(19) United States
(12) Patent Application Publication
(10) Pub. No.: US 2026/0098991 A1
(43) Pub. Date: Apr. 9, 2026

(54) OPTICAL FILM, LENS, AND VIRTUAL REALITY DISPLAY APPARATUS

(71) Applicant: FUJIFILM Corporation, Tokyo (JP)

(72) Inventors: Naoyoshi YAMADA, Minamiashigara-shi (JP); Katsumi SASATA, Minamiashigara-shi (JP); Yu NAITO, Minamiashigara-shi (JP); Ryuji SANETO, Minamiashigara-shi (JP)

(73) Assignee: FUJIFILM Corporation, Tokyo (JP)

(21) Appl. No.: 19/415,888

(22) Filed: Dec. 11, 2025

Related U.S. Application Data
(63) Continuation of application No. PCT/JP2024/022546, filed on Jun. 21, 2024.

(30) Foreign Application Priority Data
Jun. 28, 2023 (JP) 2023-106332
Jul. 10, 2023 (JP) 2023-113276
Feb. 21, 2024 (JP) 2024-024294

(51) Int. Cl. G02B 5/30

(52) U.S. Cl. CPC G02B 5/3016

(57) ABSTRACT

An object is to provide an optical film having a curved surface, in which occurrence of light leakage can be suppressed in a case of being applied to a virtual reality display apparatus; a lens using the optical film; and a virtual reality display apparatus using the lens. The object is achieved by an optical film having a curved surface, in which a curvature of the curved surface is in a predetermined curvature range, and a thickness distribution on the curved surface is larger than a predetermined value.

### CROSS-REFERENCE TO RELATED APPLICATIONS

This application is a Continuation of PCT International Application No. PCT/JP2024/022546 filed on Jun. 21, 2024, which claims priority under 35 U.S.C. § 119(a) to Japanese Patent Application No. 2023-106332 filed on Jun. 28, 2023, Japanese Patent Application No. 2023-113276 filed on Jul. 10, 2023, and Japanese Patent Application No. 2024-024294 filed on Feb. 21, 2024. The above applications are hereby expressly incorporated by reference, in their entirety, into the present application.

### BACKGROUND OF THE INVENTION

### 1. Field of the Invention

The present invention relates to an optical film having a curved surface, a lens using the optical film, and a virtual reality display apparatus using the lens.

### 2. Description of the Related Art

A virtual reality display apparatus is a display device which can obtain a realistic effect as if entering a virtual world by wearing a dedicated headset on a head and visually recognizing a video displayed through a composite lens.

It has been known that the virtual reality display apparatus includes an image display device and a Fresnel lens, but a distance from the image display device to the Fresnel lens is large, and thus a headset is thick and has poor wearability, which are problems.

Therefore, as disclosed in JP2020-519964A, U.S. Ser. No. 10/394,040B, and the like, a lens configuration of a composite lens called a pancake lens has been proposed, the lens configuration including an image display device, a half mirror, a retardation layer, and a reflective polarizer, and causing rays emitted from the image display device to reciprocate between the half mirror and the reflective polarizer to increase an optical path length and reduce a thickness of the entire headset.

The reflective polarizer herein is a polarizer having a function of reflecting one polarized light in incidence ray and transmitting the other polarized light.

For example, in a case where polarized light incident on the reflective polarizer is linearly polarized light, the reflected light and the transmitted light are orthogonal linearly polarized light. In addition, in a case where polarized light incident on the reflective polarizer is circularly polarized light, the reflected light and the transmitted light are circularly polarized light having opposite rotation directions.

As the reflective linear polarizer in which the transmitted light and the reflected light are linearly polarized, for example, a film in which a dielectric multi-layer film is stretched, a wire grid polarizer, and the like have been known. In addition, as a reflective circular polarizer in which the transmitted light and the reflected light are converted into circularly polarized light, for example, a cholesteric liquid crystal layer having a light reflective layer in which a cholesteric liquid crystalline phase is fixed has been known.

### SUMMARY OF THE INVENTION

JP2020-519964A discloses a method of bonding a laminated optical body on a curved surface of a spherical surface of an aspherical surface of an optical lens in order to obtain a wide visual field, low chromatic aberration, low distortion, and excellent modulation transfer function (MTF).

However, in order to bond the laminated optical body including the optically anisotropic layer to the curved surface, it is necessary to form the laminated optical body into a three-dimensional shape including the curved surface. In a case where the optically anisotropic layer is stretched, there is a problem in that phase difference is exhibited in the optically anisotropic layer or phase difference inherent in the optically anisotropic layer is changed.

In addition, in the forming into the three-dimensional shape including the curved surface, there is a problem in that an amount of exhibited phase difference and an amount of change vary depending on a position depending on a stretching state. In a case where the optically anisotropic layer is a retardation layer such as a λ/4 retardation layer, the phase difference of the optically anisotropic layer may be unintentionally expressed due to the expression of the undesirable phase difference. Furthermore, an optical axis of the optically anisotropic layer may be changed to an unintended orientation.

In addition, as the optically anisotropic layer, a layer which does not usually have a phase difference, such as a cholesteric liquid crystal layer, is also known.

In a case where such an optically anisotropic layer which does not usually have a phase difference is formed into the three-dimensional shape including the curved surface, the optically anisotropic layer may exhibit a new phase difference by being stretched. For example, in a case where the cholesteric liquid crystal layer exhibits the phase difference, there may be a problem in that the reflected polarized light is not intended circularly polarized light but elliptically polarized light.

According to the studies of the present inventors, it has been found that the expression of such an undesirable phase difference and the change in phase difference disturb the polarization of rays emitted from the image display device in a virtual reality display apparatus using the pancake lens, and thus a part of the rays is to be leaked light, which leads to double images and a decrease in contrast.

In addition, JP2020-519964A discloses a virtual reality display apparatus using a reflective linear polarizer as the reflective polarizer, and using an image display panel and a composite lens having a pancake lens configuration including a reflective linear polarizer and a half mirror. In this case, the image display panel, the reflective linear polarizer, and the half mirror are arranged in this order. In a case of including the image display panel, the reflective linear polarizer, and the half mirror in this order, it is necessary for the reflective linear polarizer to have an action of a concave mirror with respect to a ray incident from the half mirror side. In response to this, in order to impart the action of the concave mirror to the reflective linear polarizer, a configuration in which the reflective linear polarizer is formed into a curved shape is proposed.

On the other hand, U.S. Ser. No. 10/394,040B also discloses a virtual reality display apparatus using a reflective linear polarizer as the reflective polarizer, and including an image display panel and a composite lens having a pancake lens configuration including a reflective linear polarizer and a half mirror. In U.S. Ser. No. 10/394,040B, the image display panel, the half mirror, and the reflective linear polarizer are arranged in this order. Here, U.S. Ser. No. 10/394,040B proposes a configuration in which both the half mirror and the reflective linear polarizer are curved to improve field curvature. In this case, it is necessary for the reflective linear polarizer to have an action of a convex mirror.

In such a composite lens, it is preferable to provide a retardation film which converts circularly polarized light into linearly polarized light, between the reflective linear polarizer and the half mirror. In this case, it is preferable to handle the reflective linear polarizer and the retardation film as a laminated optical body in which both are laminated.

However, according to the studies of the present inventors, in a case where the laminated optical body in which the reflective linear polarizer and the retardation film are laminated is formed into the curved shape, a phase difference of the retardation film is changed. As a result, it has been found that it is not possible to appropriately reflect and transmit incident linearly polarized light, and thus light leakage is increased. In the virtual reality display apparatus, in a case where the light leakage is increased, a ghost is visually recognized.

The present invention has been made in view of the above-described circumstances, and an object to be achieved by the present invention is to provide an optical film which suppresses occurrence of light leakage in a case of being applied to a pancake lens-type virtual reality display apparatus. Another object of the present invention is to provide a virtual reality display apparatus using the above-described optical film.

As a result of intensive studies repeatedly conducted by the present inventors on the above-described object, it has been found that the above-described object can be achieved by the following configurations.

[1] An optical film having a curved surface,
in which an average curvature radius on the curved surface is 30 to 1,000 mm, and
in a case where a maximum thickness of the optical film on the curved surface is denoted as t_max and a minimum thickness of the optical film on the curved surface is denoted as t_min,

$$( t\_max - t\_min ) / t\_min > R - 1 is satisfied ,$$

here, R is a ratio of a surface area of the curved surface to a projected area of the curved surface projected onto a plane perpendicular to an optical axis.

[2] The optical film according to [1],
in which the optical film comprises at least a retardation layer,
the retardation layer includes at least a first optically anisotropic layer and a second optically anisotropic layer, and
in a case where a thickness of the first optically anisotropic layer at a point X on the curved surface is denoted as t1(x) and a thickness of the second optically anisotropic layer at the point X is denoted as t2(x), a variation of t1(x)/t2(x) on the curved surface is less than 5%.

[3] The optical film according to [2],
in which a variation in slow axis of each of the first optically anisotropic layer and the second optically anisotropic layer is less than 2°.

[4] The optical film according to [2] or [3],
in which an in-plane phase difference of the first optically anisotropic layer at a wavelength of 550 nm is in a range of 120 to 160 nm, and an in-plane phase difference value of the second optically anisotropic layer is 200 to 320 nm.

[5] The optical film according to any one of [2] to [4],
in which the first optically anisotropic layer and the second optically anisotropic layer are layers formed by immobilizing at least a liquid crystal compound.

[6] The optical film according to any one of [2] to [5],
in which the first optically anisotropic layer is a layer formed by immobilizing at least a liquid crystal compound and is a positive A-plate, and the second optically anisotropic layer is a layer formed by immobilizing a twist-aligned liquid crystal compound, the layer having a helical axis along a thickness direction.

[7] The optical film according to any one of [2] to [6],
in which an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

[8] The optical film according to any one of [2] to [7],
in which the first optically anisotropic layer is a layer formed by immobilizing a twist-aligned liquid crystal compound, the layer having a helical axis along a thickness direction, the second optically anisotropic layer is a layer formed by immobilizing a twist-aligned liquid crystal compound, the layer having a helical axis along a thickness direction, and a helical pitch of the first optically anisotropic layer is different from a helical pitch of the second optically anisotropic layer.

[9] The optical film according to any one of [2] to [8],
in which an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

[10] The optical film according to any one of [2] to [9],
in which any of the first optically anisotropic layer or the second optically anisotropic layer has reverse wavelength dispersibility.

[11] The optical film according to any one of [2] to [10],
in which both the first optically anisotropic layer and the second optically anisotropic layer have reverse wavelength dispersibility.

[12] The optical film according to any one of [1] to [11],
in which the optical film comprises at least an absorptive polarizer, and in a case where an orientation of an absorption axis of the absorptive polarizer in the curved surface is projected onto a plane, a variation of the projected orientation of the absorption axis is less than 2°.

[13] The optical film according to any one of [1] to [12],
in which the optical film comprises at least a reflective linear polarizer, and in a case where an orientation of a reflection axis of the reflective linear polarizer in the curved surface is projected onto a plane, a variation of the projected orientation of the reflection axis is less than 2°.

[14] The optical film according to any one of [1] to [12],
in which the optical film comprises at least a reflective circular polarizer.

[15] The optical film according to [14],
in which the reflective circular polarizer includes a cholesteric liquid crystal layer.

[16] A lens comprising:
the optical film according to any one of [1] to [15].

[17] A virtual reality display apparatus comprising:
the lens according to [16].

According to the present invention, it is possible to provide an optical film which suppresses occurrence of light leakage in a case of being applied to a virtual reality display apparatus using a pancake lens. In addition, according to the present invention, it is possible to provide a virtual reality display apparatus using the above-described optical film.

### BRIEF DESCRIPTION OF THE DRAWINGS

FIG. 1 is a cross-sectional view conceptually showing an example of the optical film according to the embodiment of the present invention.

FIG. 2 is a cross-sectional view conceptually showing another example of the optical film according to the embodiment of the present invention.

FIG. 3 is a view for describing an example of a forming method of the optical film according to the embodiment of the present invention.

FIG. 4 is a top view of an optical film having a planar shape, used in the forming method shown in FIG. 3.

FIG. 5 is an example of a pattern drawn on the optical film in order to investigate an in-plane variation of optical characteristics of the optical film.

FIG. 6 is a view for describing another example of a forming method of the optical film according to the embodiment of the present invention.

FIG. 7 is a view conceptually showing an example of the virtual reality display apparatus according to the embodiment of the present invention.

FIG. 8 is a view conceptually showing another example of the virtual reality display apparatus according to the embodiment of the present invention.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In addition, in the present specification, a liquid crystal composition and a liquid crystal compound include those which no longer exhibit liquid crystal properties due to curing or the like as a concept.

Hereinafter, the present invention will be described in detail with reference to the accompanying drawings.

The description of the configuration requirements described below may be made based on representative embodiments, specific examples, and the like, but the present invention is not limited to such embodiments.

Any numerical range expressed using “to” in the present specification refers to a range including the numerical values before and after the “to” as a lower limit value and an upper limit value, respectively.

In the present specification, the term “orthogonal” does not denote 90° in a strict sense, but denotes 90°±10°, preferably 90°±5°. In addition, a term “parallel” does not denote 0° in a strict sense, but denotes 0°±10°, preferably 0°±5°. Furthermore, a term “45°” does not denote 45° in a strict sense, but denotes 45°±10°, preferably 45°±5°.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which refractive index is maximized in a plane.

In the present specification, a phase difference denotes an in-plane retardation unless otherwise specified, and is referred to as Re (λ). Here, Re (λ) represents an in-plane retardation at a wavelength λ, and the wavelength λ is 550 nm unless otherwise specified.

In addition, a retardation at the wavelength λ in a thickness direction is referred to as Rth (λ) in the present specification. The wavelength λ is set to 550 nm unless otherwise specified.

As Re (λ) and Rth (λ), for example, values measured at the wavelength λ with AxoScan OPMF-1 (manufactured by Opto Science, Inc.) can be used. By inputting an average refractive index ((nx+ny+nz)/3) and a film thickness (d (μm)) in AxoScan, a slow axis direction (°), Re(λ)=R0(λ), and Rth(λ)=((nx+ny)/2−nz)×d are calculated.

In the present specification, “effective phase difference” and “effective slow axis” represent, for example, an effective in-plane phase difference value calculated from a change in polarization state with respect to a predetermined polarization, in an optical film or the like in which a plurality of optical films are laminated, and an effective slow axis orientation calculated by the same method. Specifically, the effective phase difference and the effective slow axis can be obtained as follows.

That is, using KOBRA 21ADH or WR (manufactured by Oji Scientific Instruments), linearly polarized light having a wavelength λ nm is incident in a normal direction of the optical film, and a transmitted light intensity is measured through an analyzer (linear polarizer disposed at a predetermined angle) after the light is transmitted through the optical film. By simulating from the transmitted light intensity measured by changing a relative angle between the optical film and the analyzer with respect to an orientation of the incident linearly polarized light in various ways, the effective in-plane phase difference and the effective slow axis orientation of the optical film are obtained.

In a case of selecting the measurement wavelength λ nm, a wavelength selective filter can be manually exchanged, or a measurement value can be converted using a program or the like to perform the measurement.

Unless otherwise specified, the measurement wavelength is λ=550 nm. Regarding this point, the same applies to other optical characteristics.

According to the present measurement method, even in a case of a composite retardation plate in which an optical retardation effect changes depending on the incident polarization, the effective in-plane phase difference value and the effective slow axis orientation at each position in the plane can be measured.

The effective phase difference value can also be obtained using AxoScan.

Specifically, using AxoScan, light having a wavelength λ nm is incident in a normal direction of the optical film to obtain a Mueller matrix of the optical film. Furthermore, from the obtained Mueller matrix, a polarization state of the emitted light in a case where light in various polarization states is incident on the optical film can be obtained, and the in-plane phase difference value of each optically anisotropic layer and the orientation angle of the slow axis of each optically anisotropic layer can be obtained from the change in the polarization state. From these values, the effective phase difference value of the optical film can be obtained.

### <Optical Film>

The optical film according to the embodiment of the present invention has a curved surface. The curved surface means a shape having a curvature of more than 0, and includes a curved shape which is a developable surface and a three-dimensional curved shape.

The developable surface is a surface which is developable onto a plane without stretching or contracting any part of the surface. Examples of the curved shape which is a developable surface include surfaces corresponding to a cylindrical peripheral surface, an elliptical cylindrical peripheral surface, a conical peripheral surface, an elliptical conical peripheral surface, and the like; and the curved shape may be a convex curved surface or a concave curved surface. The three-dimensional curved surface means a curved surface which cannot be formed by deforming a plane, that is, a non-developable curved surface. Examples of the three-dimensional curved surface include a surface corresponding to a spherical surface, a rotational ellipsoidal surface, or the like, and a surface corresponding to a curved surface (for example, a rotational parabolic surface) having a cross section of a parabola, a hyperbola, or the like. In addition, the three-dimensional curved surface may be a convex curved surface or a concave curved surface.

The curved surface is preferably lens-like. Examples of the lens-like curved surface include a spherical surface shape and a rotational ellipsoid surface shape; and the lens-like curved shape may be a convex lens-like shape or a concave lens-like shape.

Preferred examples of the shape of the curved surface of the optical film according to the embodiment of the present invention include a spherical shape, a rotational ellipsoidal shape, and a rotational paraboloid shape.

The optical film according to the embodiment of the present invention has a shape of the curved surface, and exhibits a predetermined curvature radius. That is, a portion of the optical film having a curved surface exhibits a predetermined curvature radius. The portion having a curved surface, that is, a non-planar shape portion is preferably a curved shape portion.

In the optical film according to the embodiment of the present invention, an average curvature radius on the curved surface is 30 to 1,000 mm.

As the average curvature radius of the optical film on the curved surface is less than 30 mm, in a case where the optical film is applied to a virtual reality display apparatus or the like, a size of a lens is reduced, and thus there is a problem in that wearing comfort deteriorates.

On the contrary, as the average curvature radius of the optical film on the curved surface is more than 1,000 mm, in a case where the optical film has an action as a concave mirror, a focal length is increased, and as a result, there is a problem in that the virtual reality display apparatus is thickened, and the improvement of field curvature is insufficient.

From the viewpoint of further suppressing the occurrence of light leakage in a case where the optical film according to the embodiment of the present invention is applied to a pancake lens-type virtual reality display apparatus, the average curvature radius of the optical film on the curved surface is preferably 30 to 100 mm. The curvature radius may be constant or may vary at any position of the optical film. In the following description, the “viewpoint that the occurrence of light leakage is further suppressed in a case where the optical film is applied to a pancake lens-type virtual reality display apparatus” is also simply referred to as “viewpoint that the effect of the present invention is more excellent”.

In the optical film according to the embodiment of the present invention, in a case where the maximum thickness of the optical film on the curved surface is denoted as t_max and the minimum thickness thereof is denoted as t_min, the following expression (1) is satisfied.

$$( t\_max - t\_min ) / t\_min > R - 1 \qquad Expression ( 1 )$$

In the expression (1), R is a ratio of a surface area of the curved surface to a projected area of the curved surface projected onto a plane perpendicular to an optical axis. Specifically, R is defined by the following expression (2).

$$R = Surface area of curved surface / Projected area of curved surface projected onto plane perpendicular to optical axis \qquad Expression ( 2 )$$

In the following description, the “projected area of the curved surface projected onto a plane perpendicular to an optical axis” is also referred to as “projected area of the curved surface”.

Here, in the optical film according to the embodiment of the present invention having a curved surface, the projected area of the curved surface is, in other words, a projected area in a case where the curved surface is projected onto a plane perpendicular to a normal line of the curved surface at a bottom (that is, a top) of the curved surface. In the optical film according to the embodiment of the present invention having a curved surface, the optical axis is the normal line of the curved surface at a bottom of the curved surface. Therefore, in a case where the optical film according to the embodiment of the present invention is adhered (bonded) to an optical element such as a lens having an optical axis, an optical axis of the optical element and the optical axis of the optical film according to the embodiment of the present invention usually coincide with each other. In a case where the optical film according to the embodiment of the present invention having a curved surface has an optically clear optical axis as an optical element such as a lens, the optical axis is defined as the optical axis of the optical film according to the embodiment of the present invention.

As shown in the expression (1), the optical film according to the embodiment of the present invention has a curved surface, and has a film thickness distribution in the curved surface.

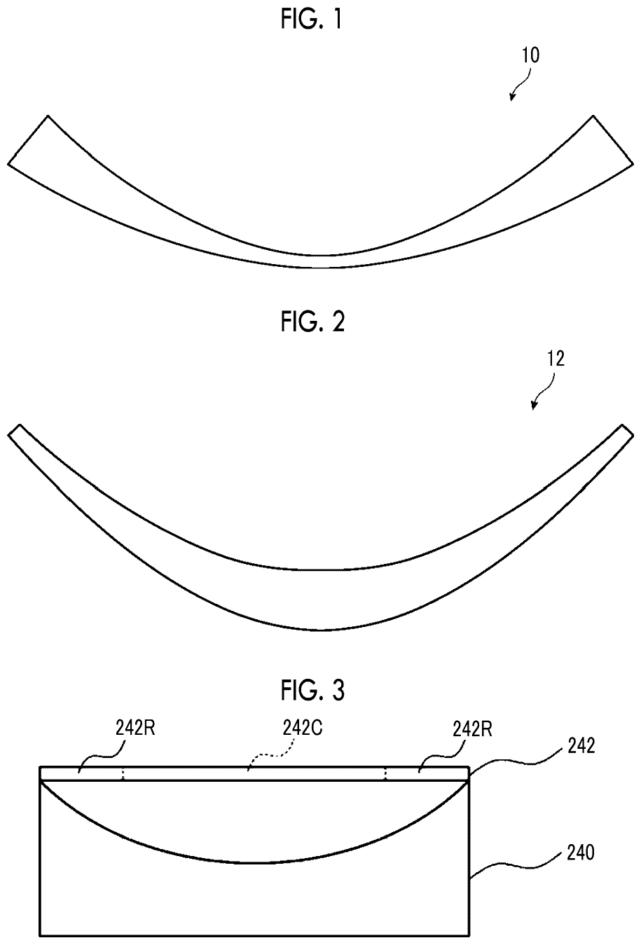

As an example, the optical film according to the embodiment of the present invention has a film thickness distribution in which the curved surface is thickest at an end part, gradually thins toward a bottom portion, and is thinnest at the bottom portion, as shown in an optical film 10 conceptually shown in FIG. 1. Alternatively, as another example, the optical film according to the embodiment of the present invention has a film thickness distribution in which the curved surface is thinnest at an end part, gradually thickens toward a bottom portion, and is thickest at the bottom portion, as shown in an optical film 12 conceptually shown in FIG. 2.

FIGS. 1 and 2 are views conceptually showing cross sections of the examples of the optical film according to the embodiment of the present invention, cut by a straight line passing through the bottom of the curved surface, that is, the optical axis.

According to the studies of the present inventors, it has been found that, in a case where the optical film having a curved surface satisfies the expression (1), a variation in optical performance of the optical film on the curved surface can be reduced.

As described above, in a case where a retardation film, a cholesteric liquid crystal layer, or the like is formed into a curved shape, various problems occur, such as a variation in phase difference and a change in orientation of the optical axis in a case of the retardation film, and elliptical polarization of reflected circularly polarized light in a case of the cholesteric liquid crystal layer.

As a result of the studies, the present inventors have found that one of the causes is that stretching during the forming into the curved surface is not isotropic, and a stretching rate varies depending on the direction. That is, in a case of the retardation film, various problems occur due to the anisotropic stretching, such as the change in orientation of the optical axis and the variation in phase difference. In addition, in a case of the cholesteric liquid crystal layer, a phase difference which is not originally present is exhibited, and the reflected circularly polarized light is elliptically polarized.

On the other hand, in the optical film according to the embodiment of the present invention, in a case where the maximum thickness on the curved surface is denoted as t_max and the minimum thickness on the curved surface is denoted as t_min, t_max and t_min satisfy the expression (1) of (t_max−t_min)/t_min>R−1.

That is, the optical film according to the embodiment of the present invention has a certain degree of large film thickness distribution on the curved surface, and as R obtained by dividing the surface area of the curved surface by the projected area of the curved surface is larger, that is, as the curvature of the curved surface is larger, the film thickness distribution is larger.

The optical film according to the embodiment of the present invention, having such a film thickness distribution, is isotropically stretched during the forming into the curved shape, and thus the variation in optical performance on the curved surface can be reduced even though the optical film has the curved surface.

Therefore, for example, in a case where the optical film according to the embodiment of the present invention is used for a pancake lens-type virtual reality display apparatus or the like, it is possible to display a virtual reality image with few ghosts by suppressing the occurrence of light leakage.

In the optical film according to the embodiment of the present invention, the maximum thickness t_max and the minimum thickness t_min on the curved surface are measured as follows.

In a projection image in a case of measuring the above-described projected area of the curved surface, as conceptually shown in FIG. 5, three concentric circles at equal intervals are set between the optical axis and an end part of the curved surface with the optical axis (bottom) as a center. In a case where an outer shape of the projection image of the curved surface is not circular, the largest circle inscribed in the outer shape of the projection image may be set, and the three concentric circles at equal intervals may be set with the circle as the outer shape of the curved surface.

Next, four straight lines passing through the optical axis (bottom) are set at 450 intervals in an azimuthal direction.

Thereafter, a thickness of the curved surface (optical film) is measured at a total of 33 points including the optical axis and 4×8=32 points corresponding to the intersection between the concentric circles and the outer shape of the curved surface, and the four straight lines passing through the optical axis.

The thickness of the curved surface is a thickness in a normal direction of the curved surface at the measurement point. In addition, the thickness of the optical film may be measured, for example, by cutting the optical film perpendicularly (in the normal direction of the curved surface) and observing a cross section with an optical microscope, a scanning electron microscope (SEM), or the like.

From the measurement results of the thicknesses of the 33 measurement points measured in this way, the maximum thickness may be defined as the maximum thickness t_max on the curved surface, and the minimum thickness may be defined as the minimum thickness t_min on the curved surface.

In the optical film according to the embodiment of the present invention, in a case where (t_max−t_min)/t_min is equal to or less than R−1, the film thickness distribution is insufficient, and thus there is a problem such as that light leakage cannot be sufficiently suppressed in a case where the optical film according to the embodiment of the present invention is used for a virtual reality display apparatus, double images occur, or contrast is reduced.

(t_max−t_min)/t_min is preferably equal to or more than 1.5×(R−1), and more preferably equal to or more than 2.0×(R−1).

The upper limit of (t_max−t_min)/t_min is not limited, but is usually equal to or less than 5.0×(R−1).

The optical film according to the embodiment of the present invention can be used as various optical members such as a retardation film, an absorptive polarizer, a reflective linear polarizer, and a reflective circular polarizer.

### <Retardation Film>

In the following description, the “retardation film” is also referred to as “retardation layer”.

The optical film according to the embodiment of the present invention may be a retardation layer.

The retardation layer preferably includes at least a first optically anisotropic layer and a second optically anisotropic layer. In this case, in a case where a thickness of the first optically anisotropic layer at a point X on the curved surface is denoted as t1(x) and a thickness of the second optically anisotropic layer at the point X is denoted as t2(x), a variation of t1(x)/t2(x) on the curved surface is preferably less than 5%, and more preferably less than 3%.

In a case where the variation of t1(x)/t2(x) on the curved surface is within the above-described range, the variation in effective in-plane phase difference of the retardation layer can be reduced, which is preferable. From the viewpoint of reducing light leakage of the virtual reality display apparatus, the variation in effective in-plane phase difference is preferably less than 5%, and more preferably less than 3%.

In addition, in a case where the variation of t1(x)/t2(x) on the curved surface is within the above-described range, the variation in orientation of the effective slow axis of the retardation layer can be reduced in a case where the retardation layer is projected onto a plane perpendicular to the optical axis of the curved surface, which is preferable.

In a case where the optical film according to the embodiment of the present invention is used as the retardation layer, it is preferable that the variation in orientation of the slow axis is also small. Specifically, from the viewpoint of reducing light leakage of the virtual reality display apparatus, the variation in orientation of the slow axis is preferably less than 2°, and more preferably less than 1°. In addition, the variation in slow axis of each of the first optically anisotropic layer and the second optically anisotropic layer is preferably less than 2°, and more preferably less than 1°.

In a case where the retardation layer has a first retardation layer and a second retardation layer, the retardation layer is also preferably a laminated film in which an effective in-plane phase difference of the first optically anisotropic layer at a wavelength of 550 nm is in a range of 120 nm to 160 nm and an effective in-plane phase difference value of the second optically anisotropic layer is 200 to 320 nm. In addition, in this case, it is preferable that the orientation of the slow axis of the first optically anisotropic layer and the orientation of the slow axis of the second optically anisotropic layer are at an angle of 60°±10°.

In a case where the in-plane phase difference of each optically anisotropic layer is within the above-described range, the retardation layer can have an effective in-plane phase difference of λ/4 phase difference over a wide wavelength range of visible light, and can convert linearly polarized light into circularly polarized light over the same wavelength range. Similarly, the retardation layer can convert circularly polarized light into linearly polarized light.

In addition, in a case where the retardation layer has a first retardation layer and a second retardation layer, it is preferable that any of the first optically anisotropic layer or the second optically anisotropic layer has reverse wavelength dispersibility, and it is more preferable that both the first optically anisotropic layer and the second optically anisotropic layer have reverse wavelength dispersibility. In this case, the effective in-plane phase difference can be further strictly set to λ/4 phase difference over a wide wavelength range of visible light, which is preferable.

The reverse wavelength dispersibility refers to a property in which an Re value increases as a measurement wavelength increases in a case of measuring the in-plane retardation (Re) value at a specific wavelength (visible light range). It is preferable that Re(450)/Re(550)<1.00 and Re(650)/Re(550)>1.00 are satisfied.

The optically anisotropic layer having reverse dispersibility can be produced, for example, by uniaxially stretching a polymer film such as a modified polycarbonate resin film having reverse wavelength dispersibility with reference to JP2017-049574A and the like.

In addition, the optically anisotropic layer having reverse wavelength dispersibility can also be produced, for example, by aligning and immobilizing a rod-like liquid crystal compound having reverse wavelength dispersibility with reference to JP2020-084070A and the like.

In a case where the retardation layer has a first retardation layer and a second retardation layer, it is also preferable that at least one of the first optically anisotropic layer or the second optically anisotropic layer is a layer formed by immobilizing a twist-aligned liquid crystal compound, the layer having a helical axis along a thickness direction.

With such a configuration, the retardation layer can have an effective in-plane phase difference of λ/4 phase difference over a wide wavelength range of visible light, and can convert linearly polarized light into circularly polarized light over a wide wavelength range of visible light. Similarly, the retardation layer can convert circularly polarized light into linearly polarized light.

In a case where the retardation layer has a first retardation layer and a second retardation layer, it is preferable that the first optically anisotropic layer or the second optically anisotropic layer are layers formed by immobilizing at least a liquid crystal compound. In the liquid crystal compound, since liquid crystal molecules can be aligned in any orientation using an alignment film or the like, a manufacturing step of the retardation layer can be simplified.

In addition, it is also preferable that an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer. With such a configuration, a difference in refractive index at the interface between the first optically anisotropic layer and the second optically anisotropic layer can be reduced, and interface reflection can be suppressed, so that disturbance in the polarization state due to the interface reflection can be suppressed, and the ghost image can be further reduced.

In the present specification, the alignment directions of the liquid crystal compounds being continuous at the interface means that an in-plane slow axis on a surface of the first optically anisotropic layer on the second optically anisotropic layer side and an in-plane slow axis on a surface of the second optically anisotropic layer on the first optically anisotropic layer side are parallel to each other. That is, in a case where the alignment directions of the liquid crystal compounds are continuous at the interface, an angle between the in-plane slow axis on a surface of the first optically anisotropic layer on the second optically anisotropic layer side and the in-plane slow axis on a surface of the second optically anisotropic layer on the first optically anisotropic layer side is within 10° (0° to 10°).

In a case where the retardation layer has a first retardation layer and a second retardation layer, it is also preferable that the first optically anisotropic layer is a positive A-plate and the second optically anisotropic layer is a layer formed by immobilizing a twist-aligned liquid crystal compound, the layer having a helical axis along a thickness direction. Here, the positive A-plate is a retardation layer in which Re has a certain value and Rth has a substantially ½ value of Re. The positive A-plate can be obtained, for example, by horizontally aligning rod-like liquid crystal compounds. In this case, it is also preferable that an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

In the first optically anisotropic layer, a product of a refractive index anisotropy Δn1 at a wavelength of 550 nm and a thickness d1 preferably satisfies the following expression (3).

$$140 nm \leq Δ n 1 d 1 \leq 220 nm \qquad Expression ( 3 )$$

In addition, in the second optically anisotropic layer, a product of a refractive index anisotropy Δn2 at a wavelength of 550 nm and a thickness d2 preferably satisfies the following expression (4).

$$150 nm \leq Δ n 2 d 2 \leq 230 nm \qquad Expression ( 4 )$$

Furthermore, it is preferable that the second optically anisotropic layer is a layer formed by immobilizing a twist-aligned liquid crystal compound, the layer having a helical axis along a thickness direction, and a twist angle thereof is 85°±20°.

In a case where the first optically anisotropic layer and the second optically anisotropic layer have the above-described configurations, the retardation layer can be set to a λ/4 retardation layer over a wider wavelength range.

The retardation layer as described above can refer to, for example, those described in WO2021/261435A.

In a case where the retardation layer has a first retardation layer and a second retardation layer, it is also preferable that both the first optically anisotropic layer or the second optically anisotropic layer are layers formed by immobilizing a twist-aligned liquid crystal compound, the layers having a helical axis along a thickness direction. In addition, in this case, it is preferable that a helical pitch of the first optically anisotropic layer is different from a helical pitch of the second optically anisotropic layer. Furthermore, in this case, it is also preferable that an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

In this case, in the first optically anisotropic layer, a product of a refractive index anisotropy Δn1 at a wavelength of 550 nm and a thickness d1 preferably satisfies the following expression (5).

$$252 nm \leq Δ n 1 d 1 \leq 312 nm \qquad Expression ( 5 )$$

In addition, it is preferable that the first optically anisotropic layer is a layer formed by immobilizing a twist-aligned liquid crystal compound, the layer having a helical axis along a thickness direction, and a twist angle thereof is 26.5°±10°.

Furthermore, in the second optically anisotropic layer, a product of a refractive index anisotropy Δn2 at a wavelength of 550 nm and a thickness d2 preferably satisfies the following expression (6).

$$110 nm \leq Δ n 2 d 2 \leq 170 nm \qquad Expression ( 6 )$$

In addition, it is preferable that the second optically anisotropic layer is a layer formed by immobilizing a twist-aligned liquid crystal compound, the layer having a helical axis along a thickness direction, and a twist angle thereof is 78.6°±10°.

In a case where the first optically anisotropic layer and the second optically anisotropic layer have the above-described configurations, the retardation layer can be set to a λ/4 retardation layer over a wider wavelength range.

The retardation layer as described above can refer to, for example, those described in WO2021/261435A.

In addition, it is also preferable that both the first optically anisotropic layer and the second optically anisotropic layer are positive A-plates.

### [Method of Bonding Each Layer]

In a case where the retardation layer has a first retardation layer and a second retardation layer, the first optically anisotropic layer and the second optically anisotropic layer may be manufactured in separate steps, and then laminated by being bonded to each other. The bonding can be performed using an adhesive, a pressure sensitive adhesive, or the like.

From the viewpoint of suppressing the interface reflection, it is preferable that an adhesive layer between the layers is refractive index-matched to the first optically anisotropic layer and the second optically anisotropic layer. In addition, a thickness of the adhesive layer can also be appropriately set to suppress the interface reflection between the first optically anisotropic layer and the second optically anisotropic layer.

Furthermore, from the viewpoint of suppressing the interface reflection, it is also preferable that the adhesive layer between the layers has a thickness of 100 nm or less. In a case where the thickness of the adhesive layer is 100 nm or less, light in the visible region is not affected by the difference in refractive index, and extra reflection can be suppressed. The thickness of the adhesive layer is more preferably 50 nm or less.

Examples of a method of forming the adhesive layer having a thickness of 100 nm or less include a method of vapor-depositing a ceramic adhesive such as silicon oxide (SiOx layer) on an adhesive surface. The adhesive surface may be subjected to a surface modification treatment such as a plasma treatment, a corona treatment, and a saponification treatment, before the adhesion, or a primer layer may be applied. In addition, in a case where there are a plurality of adhesive surfaces, the type and thickness of the adhesive layer can be adjusted for each adhesive surface.

Specifically, for example, the adhesive layer having a thickness of 100 nm or less can be provided by the procedures (1) to (3) described below.
(1) A layer to laminate is bonded to a temporary support consisting of a glass base material.
(2) An SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; in addition, it is preferable that the surface of the formed SiOx layer is subjected to a plasma treatment.
(3) After the formed SiOx layers are bonded to each other, the temporary support is peeled off, it is preferable that the bonding is carried out, for example, at a temperature of 120° C.

The application of the adhesive and the pressure sensitive adhesive to each layer, the formation of the adhesive layer such as the SiOx layer, and the adhesion may be performed by roll-to-roll or by single-wafer.

The roll-to-roll method is preferable from the viewpoint of improving productivity, reducing axis misalignment of the layer, and the like.

Meanwhile, the single-wafer method is preferable from the viewpoints that this method is suitable for production of many kinds in small quantities and that a special adhesion method in which the thickness of the adhesive layer is 100 nm or less can be selected.

In a case where the retardation layer has a first retardation layer and a second retardation layer, examples of the method of coating the adherend with the adhesive and the pressure sensitive adhesive include known methods such as a roll coating method, a gravure printing method, a spin coating method, a wire bar coating method, an extrusion coating method, a direct gravure coating method, a reverse gravure coating method, a die-coating method, a spraying method, and an inkjet method.

### [Direct Application of Each Layer]

In a case where the retardation layer has a first retardation layer and a second retardation layer, it is also preferable that there is no adhesive layer between the first optically anisotropic layer and the second optically anisotropic layer.

In a case of forming a layer, the adhesive layer can be removed by directly coating an adjacent layer which has already been formed. For example, in a case of forming the second optically anisotropic layer on the first optically anisotropic layer, the adhesive layer can be removed by directly coating the already formed first optically anisotropic layer with a composition which forms the second optically anisotropic layer.

Furthermore, in a case where one or both adjacent layers are layers containing a liquid crystal compound, it is preferable that the alignment direction of the liquid crystal compound is continuously changed at the interface in order to reduce the difference in refractive index in all in-plane directions. For example, the composition for forming the second optically anisotropic layer, containing a liquid crystal compound, can be directly applied onto the first optically anisotropic layer containing a liquid crystal compound, and an alignment direction of the liquid crystal compound of the second optically anisotropic layer can be aligned to be continuous at the interface by an alignment restriction force of the liquid crystal compound of the first optically anisotropic layer.

### [Single Liquid Two-Layer Coating for Each Layer]

In addition, in a case where the retardation layer has a first retardation layer and a second retardation layer, the first optically anisotropic layer and the second optically anisotropic layer can be formed by applying the same forming composition and then separating the layers into two layers by various methods.

Such a retardation layer can be produced, for example, by the following steps 1 to 5.
Step 1: step of applying a polymerizable liquid crystal composition containing a chiral agent which includes at least a photosensitive chiral agent in which a helical twisting power changes by light irradiation, and a liquid crystal compound having a polymerizable group, which has reverse wavelength dispersibility, onto a support to form a composition layer
(in the following description of steps 2 to 5, the “liquid crystal compound having a polymerizable group, which has a reverse wavelength dispersibility” is also simply referred to as “liquid crystal compound”)
Step 2: step of subjecting the composition layer to a heat treatment to align the liquid crystal compound in the composition layer
Step 3: step of subjecting the composition layer after the step 2 to light irradiation under a condition of an oxygen concentration of 1% by volume or more
Step 4: step of subjecting the composition layer after the step 3 to a heat treatment
Step 5: step of subjecting the composition layer after the step 4 to a curing treatment to fix an alignment state of the liquid crystal compound, thereby forming the first optically anisotropic layer and the second optically anisotropic layer

The manufacturing steps of the retardation layer as described above can refer to, for example, steps described in WO2021/261435A.

It is also preferable that the retardation layer further includes an optically anisotropic layer in addition to the first optically anisotropic layer and the second optically anisotropic layer.

In a case where three or more optically anisotropic layers are included, a degree of freedom in the design of the retardation layer is increased, and it is easier to set the effective in-plane phase difference to the λ/4 phase difference over a wide wavelength range of visible light, which is preferable.

### <Absorptive Polarizer>

The optical film according to the embodiment of the present invention may be an absorptive polarizer. The absorptive polarizer absorbs linearly polarized light in an absorption axis direction among incidence rays, and transmits linearly polarized light in a transmission axis direction.

In a case where an orientation of the absorption axis of the absorptive polarizer in the curved surface is projected onto a plane, a variation of the projected orientation of the absorption axis is preferably less than 2°, and more preferably less than 1°.

As the absorptive polarizer, a general polarizer can be used. For example, a polarizer in which a dichroic substance is dyed on polyvinyl alcohol or another polymer resin and is stretched so that the dichroic substance is aligned may be used, or a polarizer in which a dichroic substance is aligned by using alignment of a liquid crystal compound may be used. Among these, from the viewpoint of availability and an increase in degree of polarization, a polarizer obtained by dyeing polyvinyl alcohol with iodine and stretching polyvinyl alcohol is preferable.

A thickness of the absorptive polarizer is preferably 10 μm or less, more preferably 7 m or less, and still more preferably 5 μm or less. In a case where the absorptive polarizer is thin, cracks, breakage, and the like of the film can be prevented in a case where the laminated optical body is stretched or formed.

In addition, a single-sheet transmittance of the absorptive polarizer is preferably 40% or more and more preferably 42% or more. Moreover, the degree of polarization is preferably 90% or more, more preferably 95% or more, and still more preferably 99% or more. In the present invention, the single-sheet transmittance and the degree of polarization of the absorptive polarizer are measured using an automatic polarizing film measuring device: VAP-7070 (manufactured by Jasco Corporation).

In addition, it is preferable that the direction of the transmission axis of the absorptive polarizer coincides with the direction of the polarization axis of light converted into linearly polarized light by the retardation layer. For example, in a case where the retardation layer is a layer having a phase difference of a ¼ wavelength, an angle between the transmission axis of the absorptive polarizer and the slow axis of the retardation layer is preferably approximately 45°.

It is also preferable that the absorptive polarizer is a light-absorbing anisotropic layer containing a liquid crystal compound and a dichroic substance. The absorptive polarizer containing a liquid crystal compound and a dichroic substance is preferable from the viewpoint that the thickness thereof can be reduced and cracks or breakage is unlikely to occur even in a case of being stretched or formed.

A thickness of the light-absorbing anisotropic layer is not particularly limited, but from the viewpoint of thinning, it is preferably 0.1 to 8 μm and more preferably 0.3 to 5 μm.

The absorptive polarizer containing a liquid crystal compound and a dichroic substance can be produced with reference to, for example, JP2020-023153A. From the viewpoint of improving the degree of polarization of the absorptive polarizer, an alignment degree of the dichroic substance in the light-absorbing anisotropic layer is preferably 0.95 or more and more preferably 0.97 or more.

In addition, it is preferable that the absorptive polarizer is transparent to near-infrared light in order to minimize the influence on various sensors incorporated in optical systems such as a virtual reality display apparatus and an electronic finder, in which near-infrared light for eye tracking, facial expression recognition, and iris recognition is used as a light source.

### <Reflective Linear Polarizer>

The optical film according to the embodiment of the present invention may be a reflective linear polarizer.

In a case where an orientation of a reflection axis of the reflective linear polarizer in the curved surface is projected onto a plane, a variation of the projected orientation of the reflection axis is preferably less than 2°, and more preferably less than 1°.

As the reflective linear polarizer, for example, a film stretched from a dielectric multi-layer film, a wire grid polarizer, and the like can be used.

### <Reflective Circular Polarizer>

The optical film according to the embodiment of the present invention may be a reflective circular polarizer. As the reflective circular polarizer, for example, a cholesteric liquid crystal layer can be used.

### [Cholesteric Liquid Crystal Layer]

The cholesteric liquid crystal layer is an optical member which separates incidence ray into right-circularly polarized light and left-circularly polarized light, and specularly reflects one circularly polarized light and transmits the other circularly polarized light.

For example, a cholesteric liquid crystal layer obtained by immobilizing a cholesteric liquid crystalline phase can be used, as described in JP2020-060627A. The film obtained by immobilizing a cholesteric liquid crystalline phase is preferable due to a thin film and its high degree of polarization of transmitted light.

From the viewpoint that a decrease in degree of polarization and/or a distortion of a polarization axis is suppressed in a case of being stretched or formed into a three-dimensional shape, the cholesteric liquid crystal layer is preferably used as a film for curved surface forming. In addition, a decrease in degree of polarization due to the distortion of the polarization axis is unlikely to occur.

It is preferable that the cholesteric liquid crystal layer includes a blue light reflective layer in which a reflectivity of light having a wavelength of 460 nm is 40% or more, a green light reflective layer in which a reflectivity of light having a wavelength of 550 nm is 40% or more, a yellow light reflective layer in which a reflectivity of light having a wavelength of 600 nm is 40% or more, and a red light reflective layer in which a reflectivity of light having a wavelength of 650 nm is 40% or more.

With such a configuration, high reflection characteristics can be exhibited over a wide wavelength range in the visible region, which is preferable. The above-described reflectivity is a reflectivity in a case where non-polarized light is incident on the cholesteric liquid crystal layer at each wavelength.

In addition, the blue light reflective layer, the green light reflective layer, the yellow light reflective layer, and the red light reflective layer, which are formed by fixing the cholesteric liquid crystalline phase, may have a pitch gradient layer in which the helical pitch of the cholesteric liquid crystalline phase continuously changes in the thickness direction. For example, the green light reflecting layer and the yellow light reflecting layer can be continuously produced with reference to JP2020-060627A and the like.

In addition, it is also preferable that the cholesteric liquid crystal layer includes a light reflecting layer formed by immobilizing a cholesteric liquid crystalline phase containing a rod-like liquid crystal compound, and a light reflecting layer formed by immobilizing a cholesteric liquid crystalline phase containing a disk-like liquid crystal compound.

In such a configuration, since the cholesteric liquid crystalline phase containing a rod-like liquid crystal compound has a positive Rth and the cholesteric liquid crystalline phase containing a disk-like liquid crystal compound has a negative Rth, the Rth of each other is offset, and thus the occurrence of the ghost can be suppressed even for the light incident from the oblique direction, which is preferable.

The state in which the Rth is offset is represented by an expression as follows. In an optical laminated film including n light reflective layers, in a case where the light reflective layers are named L1, L2, L3, . . . , and Ln from a light source side, the sum of Rth's of each layer from the light reflective layer L1 to the light reflective layer Li is denoted by SRthi. Specifically, the expression is as follows.

$$SRth 1 = Rth 1$$

$$SRth 2 = Rth 1 + Rth 2 …$$

$$SRthi = Rth 1 + Rth 2 … + Rthi …$$

$$SRthn = Rth 1 + Rth 2 … + Rthi … + Rthn$$

Absolute values of all of SRthi (SRth1 to SRthn) are preferably 0.3 μm or less, more preferably 0.2 μm or less, and still more preferably 0.1 μm or less. The Rthi of each layer in the above-described expression is determined by the expression for calculating Rth described above.

A thickness of the cholesteric liquid crystal layer is not particularly limited, but from the viewpoint of thinning, it is preferably 30 μm or less and more preferably 15 μm or less.

In addition, in a case where the cholesteric liquid crystal layer is stretched, formed, or the like, a reflection wavelength range of the cholesteric liquid crystal layer may shift, and thus it is preferable that the reflection wavelength range is selected in advance, considering a potential shift in wavelength. For example, in a case where an optical film obtained by immobilizing a cholesteric liquid crystalline phase is used as the cholesteric liquid crystal layer, the film extends by being stretched or formed and thus a helical pitch of the cholesteric liquid crystalline phase may be reduced. Therefore, it is preferable that the helical pitch of the cholesteric liquid crystalline phase is set to be large in advance. In addition, it is also preferable that the cholesteric liquid crystal layer includes an infrared light reflecting layer having a reflectivity of 40% or more at a wavelength of 800 nm, in consideration of the short wavelength shift of the reflection wavelength range due to the stretching or the forming.

Furthermore, in a case where a stretching ratio during the stretching, and the forming is not uniform in a plane, an appropriate reflection wavelength range may be selected at each location in the plane according to the wavelength shift caused by the stretching. That is, regions with different reflection wavelength ranges may be present in the plane. In addition, it is also preferable that the reflection wavelength range is set wider than the required wavelength range in advance in consideration that the stretching ratios at the respective locations in the plane are different from each other.

### (Method of Manufacturing Cholesteric Liquid Crystal Layer)

The cholesteric liquid crystal layer can be formed according to the following procedure of: applying a liquid crystal composition, which is obtained by dissolving a liquid crystal compound, a chiral agent, a polymerization initiator, a surfactant added as necessary, and the like in a solvent, onto a support or an underlayer formed on the support; drying the liquid crystal composition to obtain a coating film; aligning the liquid crystal compound in the coating film; and irradiating the coating film with actinic ray to cure the liquid crystal composition.

As a result, a cholesteric liquid crystal layer having a cholesteric liquid crystal structure in which the cholesteric regularity is fixed can be formed.

### [Applying Method]

Examples of a method of applying the liquid crystal composition include known methods such as a roll coating method, a gravure printing method, a spin coating method, a wire bar coating method, an extrusion coating method, a direct gravure coating method, a reverse gravure coating method, a die-coating method, a spraying method, and an inkjet method.

[Method of Imparting in-Plane Distribution to Helical Pitch]

As a method of imparting an in-plane distribution to the helical pitch of the cholesteric liquid crystal layer, for example, a method of using a chiral agent in which a helical twisting power (HTP) changes by photoisomerization is used.

Hereinafter, the details will be described.

The cholesteric liquid crystal layer obtained by applying (in some cases, and heating) a liquid crystal composition containing the chiral agent in which HTP changes by photoisomerization to be aligned is irradiated with light corresponding to the photoisomerization. As a result, HTP of the chiral agent changes, and thus the helical pitch of the cholesteric liquid crystal layer changes, and the reflection wavelength can be changed. By utilizing this property, the aligned cholesteric liquid crystal layer is irradiated with light in a patterned manner using an exposure mask or the like to be photoisomerized, thereby obtaining a pattern in which the reflection wavelength is changed only in the light-irradiated region.

After obtaining the pattern, the entire cholesteric liquid crystal layer is exposed to light for curing the liquid crystal composition, and the liquid crystal composition is polymerized, thereby finally obtaining a cholesteric liquid crystal layer (patterned cholesteric liquid crystal layer) having a helical pitch with an in-plane distribution. The patterned cholesteric liquid crystal layer after the curing no longer undergoes photoisomerization and has stable properties.

In order to effectively perform the pattern formation, it is preferable that the light irradiation for the photoisomerization and the light irradiation for the curing can be separated. In other words, in order to effectively perform the pattern formation, it is preferable that, in a case where either the photoisomerization or the curing proceeds, the other does not proceed as much as possible.

Examples of a method for separating the two include separation by oxygen concentration and separation by exposure wavelength.

First, with regard to the oxygen concentration, the photoisomerization is less affected by the oxygen concentration, but the curing is less likely to occur as the oxygen concentration is higher. The point that the curing is less likely to occur as the oxygen concentration is higher also depends on the initiator to be used.

Therefore, it is preferable that the photoisomerization is performed under a condition of a high oxygen concentration, for example, in the atmosphere, and the curing is performed under a condition of a low oxygen concentration, for example, in a nitrogen atmosphere with an oxygen concentration of 300 ppm by volume or less. As a result, the separation between the photoisomerization and the curing is easier.

In addition, with regard to the exposure wavelength, the photoisomerization by a chiral agent is likely to proceed at an absorption wavelength of the chiral agent, and the curing is likely to proceed at an absorption wavelength of the photopolymerization initiator. Therefore, in a case where the chiral agent and the photopolymerization initiator are selected such that the absorption wavelengths thereof are different from each other, it is possible to separate the photoisomerization and the curing by the exposure wavelength.

One or both of the photoisomerization and the curing may be performed under heating, as necessary. A temperature at the time of heating is preferably 25° C. to 140° C. and more preferably 30° C. to 100° C.

As another method of using the chiral agent in which the HTP is changed by the photoisomerization, there is also a method in which curing is performed in a patterned manner first and then isomerization of an uncured region is performed. That is, the aligned cholesteric liquid crystalline phase is first irradiated with light for curing in a patterned manner using an exposure mask or the like. Here, in a region where the curing has been performed in advance, the change in pitch due to the photoisomerization cannot occur. Therefore, by performing the light irradiation for photoisomerization over the entire surface after the curing, the change in pitch due to the photoisomerization occurs only in a region where the curing has not been performed in advance, and the reflection wavelength changes.

In this case as well, after obtaining the pattern, the entire cholesteric liquid crystal layer is exposed to light for curing the liquid crystal composition, and the liquid crystal composition is polymerized, thereby finally obtaining the patterned cholesteric liquid crystal layer.

### <Laminated Optical Body>

The optical film according to the embodiment of the present invention may be a laminated optical body in which a plurality of functional layers are laminated. In the laminated optical body as the optical film according to the embodiment of the present invention, it is sufficient that at least one functional layer is the optical film according to the embodiment of the present invention, but it is preferable to have a large number of the functional layers as the optical film according to the embodiment of the present invention, and all of the functional layers may be the optical film according to the embodiment of the present invention.

Examples of the functional layer include a retardation layer, a reflective linear polarizer, a reflective circular polarizer, and an absorptive polarizer. By laminating these layers, various optical functions required in the virtual reality display apparatus can be integrated. As a result, the step of bonding the laminated optical body to an image display device, a lens, or the like can be performed only once, and thus the manufacturing cost can be reduced.

In addition, the laminated optical body can further include a different functional layer for the purpose of further improving the optical action. For example, it is also preferable to include a positive C-plate, an antireflection layer, an ultraviolet absorbing layer, a hard coat layer, or the like.

### <Positive C-Plate>

The positive C-plate is a retardation layer in which the Re is substantially zero and the Rth has a negative value. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, and JP2015-200861A.

The positive C-plate functions as an optical compensation layer for increasing the degree of polarization of the transmitted light with respect to light incident obliquely. A plurality of the positive C-plates may be provided at any position of the laminated optical body.

The positive C-plate may be provided adjacent to the retardation layer or inside the retardation layer.

In a case where a layer formed by immobilizing a rod-like liquid crystal compound is used as the retardation layer, the retardation layer has a positive retardation Rth (retardation in thickness direction). Here, in a case where light is incident on the retardation layer in an oblique direction, the polarization state of the transmitted light may change due to the action of the retardation Rth, and the degree of polarization of the transmitted light may decrease. In a case where the positive C-plate is provided inside the retardation layer and/or in the vicinity thereof, the change in polarization state of the oblique incident light is suppressed and the decrease in degree of polarization of the transmitted light can be suppressed, which is preferable.

It is preferable that the positive C-plate is disposed on a surface of the retardation layer on a side opposite to the linear polarizer, but the positive C-plate may be disposed at another place. In this case, the in-plane retardation Re of the positive C-plate is preferably approximately 10 nm or less, and the retardation Rth of the positive C-plate is preferably −120 nm to −20 nm and more preferably −90 nm to −40 nm.

### <Support>

In addition, the laminated optical body may further include a support. The support can be provided at any position, and for example, in a case where the retardation layer is a film used by being transferred from the temporary support, the support can be used as a transfer destination thereof.

The type of the support is not particularly limited, but it is preferable that the support is transparent, and examples thereof include films of cellulose acylate, polycarbonate, polysulfone, polyethersulfone, polyacrylate and polymethacrylate, cyclic polyolefin, polyolefin, polyamide, polystyrene, polyester, and the like. Among these, a cellulose acylate film, a cyclic polyolefin film, polyacrylate, a polyacrylate film, or a polymethacrylate film is preferable. In addition, commercially available cellulose acetate films (for example, “TD80U”, “Z-TAC”, and the like manufactured by FUJIFILM Corporation) can also be used.

In addition, it is preferable that the support has a small phase difference from the viewpoint of suppressing the adverse effect on the degree of polarization of the transmitted light and viewpoint of facilitating the optical inspection of the laminated optical body. Specifically, the support preferably has an in-plane retardation Re of 10 nm or less, and an absolute value of the retardation Rth of 50 nm or less.

In a case where the laminated optical body is stretched or formed, it is preferable that the support has a tan δ peak temperature of 170° C. or lower.

From the viewpoint that the laminated optical body can be formed at a low temperature, the peak temperature of tan δ is preferably 150° C. or lower and more preferably 130° C. or lower.

Here, a method of measuring tan δ will be described. E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device, and the values are used to acquire tan δ (=E″/E′). Examples of the dynamic viscoelasticity measuring device include DVA-200 manufactured by IT Measurement & Control Co., Ltd.
Device: DVA-200 manufactured by IT Measurement & Control Co., Ltd.
Sample: 5 mm, length of 50 mm (gap of 20 mm)
Measurement conditions: tension mode
Measurement temperature: −150° C. to 220° C.
Heating conditions: 5° C./min
Frequency: 1 Hz

Typically in optical applications, a resin base material subjected to a stretching treatment is frequently used, and the tan δ peak temperature is frequently increased due to the stretching treatment. For example, with a triacetyl cellulose (TAC) base material, the peak temperature of tan δ is 180° C. or higher. Examples of the TAC base material include TG40 manufactured by FUJIFILM Corporation.

The support having a tan δ peak temperature of 170° C. or lower is not particularly limited, and various resin base materials can be used.

Examples of such a support include polyolefin such as polyethylene, polypropylene, and a norbornene-based polymer; a cyclic olefin-based resin; polyvinyl alcohol; polyethylene terephthalate; an acrylic resin such as polymethacrylic acid ester and polyacrylic acid ester; polyethylene naphthalate; polycarbonate; polysulfone; polyethersulfone; polyetherketone; polyphenylene sulfide, and polyphenylene oxide. Among these, from the viewpoint of being easily available from the market and having excellent transparency, a cyclic olefin-based resin, polyethylene terephthalate, or an acrylic resin is preferable, and a cyclic olefin-based resin or polymethacrylic acid ester is particularly preferable.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (TOYOBO CO., LTD.), ESCENA and SCA40 (Sekisui Chemical Co., Ltd.), ZEONOR Film (ZEON CORPORATION), and an Arton Film (JSR Corporation).

A thickness of the support is not particularly limited, and is preferably 5 to 300 μm, more preferably 5 to 100 μm, and still more preferably 5 to 30 μm.

### <Forming Method>

A method for manufacturing the above-described optical film having a curved surface is not particularly limited.

Among these, the forming method of the optical film according to the embodiment of the present invention preferably includes a step of heating the optical film having a planar shape, a step of pressing the heated optical film against a mold to deform the optical film along a shape of the mold, and a step of cutting the optical film.

Hereinafter, each of the steps will be described in detail.

### (Step of Heating Optical Film Having Planar Shape)

The optical film used in the present step is an optical film having a planar shape, which will be described below, and a predetermined shape is transferred by a mold (forming die) to obtain the above-described optical film according to the embodiment of the present invention having a curved surface.

The optical film having a planar shape includes various members which can be included in the above-described optical film having a curved surface, such as the retardation film. Here, various members included in the optical film having a planar shape also have a planar shape.

Examples of the method of heating the optical film having a planar shape include heating by bringing a heated solid into contact, heating by bringing a heated liquid into contact, heating by bringing a heated gas into contact, heating by irradiating with infrared rays, and heating by irradiating with microwaves.

In particular, heating by irradiation with infrared rays is preferable because it allows for remote heating just before the forming of the optical film.

A wavelength of the infrared rays used for the heating is preferably 1.0 to 30.0 μm and more preferably 1.5 to 5 μm.

As the IR light source, a near-infrared lamp heater in which a tungsten filament is inserted into a quartz tube, a wavelength control heater in which a mechanism for cooling a part between quartz tubes with air is provided by multiplexing the quartz tubes, or the like can be used.

In addition, by distributing the irradiation amount of infrared rays on the optical film, physical property values during the forming can be controlled according to the purpose. As a method of providing intensity distribution, a method of varying the density of the arrangement of the IR light sources, or a method of placing a filter with a patterned transmittance to infrared light between the IR light sources and the optical film can be used. Examples of the filter with a patterned transmittance include a filter in which a metal is vapor-deposited on glass, a filter in which a reflection band of a cholesteric liquid crystal layer is converted into infrared, a filter in which a reflection band is converted into infrared by a dielectric multi-layer film, and a filter on which an ink absorbing infrared rays is applied.

A temperature of the optical film is controlled by the intensity of the infrared irradiation. Specifically, the temperature of the optical film is controlled by the infrared irradiation time and/or the illuminance of the infrared irradiation. By monitoring the temperature of the optical film using a non-contact radiation thermometer, a thermocouple, or the like, the optical film can be formed at a desired temperature.

### (Step of Pressing Optical Film Against Mold to Deform Optical Film Along Shape of Mold)

As a method of pressing the heated optical film against the mold to deform the optical film along a shape of the mold, decompression and/or pressurization of the forming space is used. In addition, a method of pushing the mold can also be used.

As one aspect of the forming device used in the present step, a box 1 having an opening portion on an upper side and a box 2 having an opening portion on a lower side are provided. The opening portion of the box 1 and the opening portion of the box 2 are fitted together directly or through other holding devices to form a sealed forming space.

In the forming space, a mold having a shape corresponding to the shape (curved surface) of the optical film after the forming and a film to be formed are disposed. In this case, the mold may be an adherend to which the optical film according to the embodiment of the present invention, such as a lens, is adhered (bonded).

The film to be formed is used as a partition to divide the forming space which consists of the box 1 and the box 2 into two spaces. The mold is disposed on the box 1 side below the film to be formed.

Furthermore, the forming device includes multiple heating elements arranged in a dispersed manner to heat the film to be formed. The heating element may be disposed within the forming space, or may be disposed outside the forming space to heat the film to be formed by irradiation through a transparent window.

### (Step of Cutting Optical Film)

As a method of cutting the formed optical film into any desired shape, a cutter, scissors, a cutting plotter, or a laser cutting machine are exemplified.

### <Concept of Forming Method of Predetermined Film Thickness Distribution>

The optical film according to the embodiment of the present invention has a curved surface and has a film thickness distribution in which the film thickness of the optical film on the curved surface satisfies the above-described expression (1).

As described above, the optical film according to the embodiment of the present invention has a small variation in optical characteristics on the curved surface. It is preferable that the optical film according to the embodiment of the present invention has an in-plane variation in optical characteristics of less than 5%.

An example of a forming method of forming the optical film having the film thickness distribution on the curved surface will be described in detail.

According to the forming method, the optical film having a planar shape can be formed such that the stretching is isotropic in the plane.

Specifically, in a case where a circular film is formed into a curved surface, the optical film having a planar shape is formed such that a ratio of a stretching ratio in a diameter direction to a stretching ratio in a circumferential direction is in a range of 0.95 times to 1.05 times. In this way, the distribution of the film thickness in the optical film after the forming can be increased. In addition, by having such a large film thickness distribution, in a case where the optical film has a phase difference (effective phase difference) and a slow axis (effective slow axis), the variation in the orientation of the slow axis after the forming can be reduced. Furthermore, in a case where the optical film includes the first optically anisotropic layer and the second optically anisotropic layer, the variation in the effective in-plane phase difference after the forming can be reduced.

A range of the ratio of the stretching ratio in the diameter direction to the stretching ratio in the circumferential direction is more preferably 0.98 times to 1.02 times.

As a specific example of the forming method, a forming method of an optical film, including a step of heating an optical film having a planar shape, a step of pressing the heated optical film against a mold (adherend) to deform the optical film along a shape of the mold, and a step of cutting the deformed optical film, in which the heating step is a step of heating the optical film by irradiating the optical film with infrared rays, and an irradiation amount of the infrared rays has a distribution in a plane of the optical film, is exemplified.

In particular, in the forming method, it is preferable that the mold is substantially concave sphere, and in a case where an in-plane position of the optical film is projected onto the mold from a normal direction of a surface of the optical film, an amount of infrared irradiation to the optical film located at a vertex (bottom (optical axis)) of the concave sphere is smaller than an amount of infrared irradiation to the optical film located at an end part of the concave sphere.

That is, in the forming method, it is preferable that the mold is substantially concave sphere, and in a case where an in-plane position of the optical film is projected onto the mold from a normal direction of a surface of the optical film, a temperature of the optical film located at a vertex of the concave sphere is higher than a temperature of the optical film located at an end part of the concave sphere.

In this manner, it is possible to impart the forming characteristic in which the stretching ratio in the diameter direction decreases as the distance from the center (vertex of the concave sphere) increases. As a result, the distribution of the film thickness on the curved surface can be increased.

Hereinafter, suitable aspects of the forming method will be described in more detail.

In a case where a forming die having a concave forming surface is used, the ratio of the stretching ratio in the diameter direction to the stretching ratio in the circumferential direction of the periphery portion tends to be distorted.

That is, in a case where the optical film is pressed against a concave surface of the mold having a concave curved surface to form the optical film into a curved surface, the optical film is usually fixed to a periphery portion (edge) of the curved surface of the mold, and the optical film is pressed against the curved surface of the mold to be formed by decompression or pressurization.

Therefore, in the forming method, for example, in a case where the shape (planar shape) in a direction orthogonal to the normal line (optical axis) of the bottom is a circular curved surface, the periphery portion is fixed, so that the periphery portion of the optical film is stretched in the diameter direction but is hardly stretched in the circumferential direction. On the other hand, the optical film has an increased degree of freedom in stretching as it approaches the bottom of the concave surface, so that the optical film is stretched in both the diameter direction and the circumferential direction. That is, in the forming method, the optical film is uniaxially stretched in the periphery portion, but the optical film is isotropically stretched at a position spaced from the periphery portion.

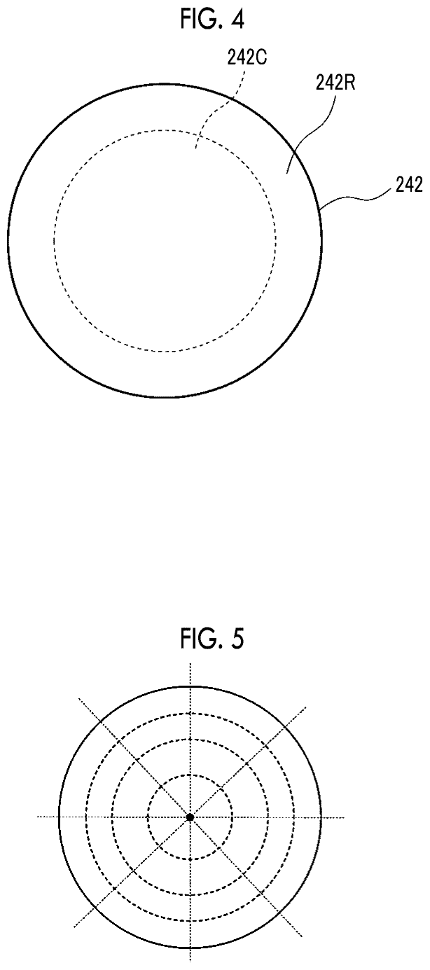

Therefore, in the above-described forming method, for example, as conceptually shown in FIGS. 3 and 4, a heating temperature of a central portion 242C of an optical film 242 having a circular planar shape, which is disposed on a forming die 240 (mold 240) having a concave forming surface, by infrared irradiation is set to be higher than a heating temperature of a periphery portion 242R of the optical film 242 by infrared irradiation. As a result, in a case where the optical film 242 is deformed along the forming surface (concave surface) of the forming die 240, the central portion 242C is easily stretched. By changing the heating conditions of the central portion and the periphery portion, the central portion can be more easily stretched and the periphery portion can be less easily stretched.

As a result, as in the optical film 10 shown in FIG. 1, the film thickness is the thickest at the periphery portion, gradually decreases toward the bottom portion, and is the thinnest at the bottom portion, whereby the optical film satisfying the above-described expression (1) of (t_max−t_min)/t_min>R−1 can be manufactured.

The optical film satisfying the expression (1) is an optical film in which, on the curved surface of the optical film, the entire surface is isotropically stretched by reducing the stretching rate of the periphery portion stretched in the uniaxial direction and increasing the stretching rate of the region of the bottom portion (central portion) stretched isotropically, and thus the in-plane variation in optical characteristics is small. Therefore, for example, in a case where the optical film is used for a pancake lens-type virtual reality display apparatus, it is possible to display a virtual reality image with less ghosts by reducing light leakage.

The method for manufacturing the optical film according to the embodiment of the present invention is not limited to the method using the forming die 240 having a concave surface as shown in FIG. 3.

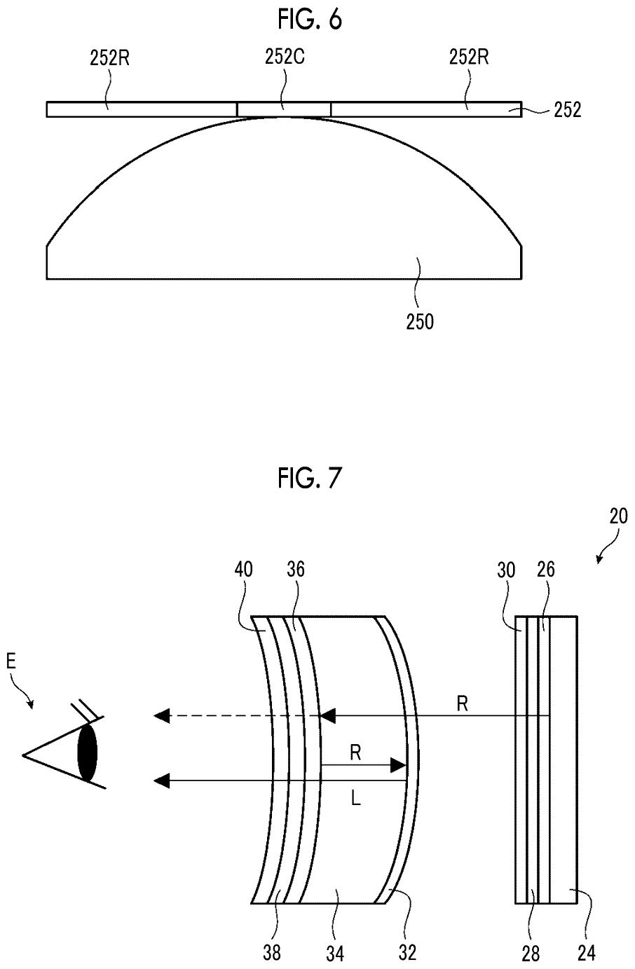

That is, the optical film according to the embodiment of the present invention can also be manufactured using a forming die 250 (mold 250) having a convex curved surface, as conceptually shown in FIG. 6. In this case, unlike the case in which the forming die 240 having a concave surface is used, an optical film 252 is usually fixed and pressurized to a top of the convex surface of the forming die 250 to press the optical film against the curved convex surface of the mold to be formed.

In the manufacturing method, for example, in a case where the optical film 252 has a circular planar shape as described above, stretching of a central portion 252C (top of the convex surface) in contact with the central portion of the forming die 250 is isotropic, and stretching of a periphery portion 252R is uniaxial along a diameter direction of the forming die 250.

In the manufacturing method, for example, the periphery portion of the optical film 252 is gripped, and the optical film 252 is stretched while being formed to expand the area of the optical film 252, so that the periphery portion of the optical film 252 can be stretched in the circumferential direction to approach isotropic stretching.

As a result, as in the optical film 12 shown in FIG. 2, the film thickness is the thickest at the central portion, gradually decreases toward the periphery, and is the thinnest at the periphery portion, whereby the optical film satisfying the above-described expression (1) of (t_max−t_min)/t_min>R−1 can be manufactured.

In the same manner as described above, the optical film satisfying the expression (1) is an optical film in which, on the curved surface of the optical film, the entire surface is isotropically stretched by reducing the stretching rate of the bottom portion (central portion) stretched in the uniaxial direction and increasing the stretching rate of the region of the periphery portion stretched isotropically, and thus the in-plane variation in optical characteristics is small. Therefore, for example, in a case where the optical film is used for a pancake lens-type virtual reality display apparatus, it is possible to display a virtual reality image with less ghosts by reducing light leakage.

### <Method of Installing Mold>

A method of installing the mold (forming die) in the forming device is not particularly limited. For example, a movable stage with a horizontal top plate can be installed in the box 1 on the lower side of the above-described forming device, and the mold can be installed on the stage. In this case, the inside of the forming device is evacuated, and then the movable stage is raised, so that the mold can be pressed against the film to be formed.

In addition, the number of molds to be installed on the stage may be one or more. From the viewpoint of improving productivity, a film to be formed, having an area larger than an area of the mold, can be used, and a plurality of molds can be installed to simultaneously produce a plurality of formed products.

### <Holding Device for Gripping Mold>

In addition, it is also preferable to grip the mold using a holding device with a recess capable of fitting the mold so that the mold does not move on the stage. In this way, the mold can be fixed to prevent movement on the stage.

In addition, it is preferable that the holding device for gripping the mold covers surfaces of the mold, other than the forming surface (surface to which the film to be formed is bonded). In a case where the film to be formed attempts to coat not only the forming surface of the mold but also the edge surface of the mold, the film to be formed is significantly stretched, which may result in significant unevenness in film thickness, optical characteristics, and the like of the film. Therefore, it is preferable to use a holding device which covers surfaces of the mold other than the forming surface to prevent the film to be formed from coming into contact with the surfaces of the mold other than the forming surface.

In addition, it is preferable that the holding device has a surface with a height substantially equal to the forming surface of the mold and a horizontal surface in the portion where the mold is not present. In this manner, the stretching of the film to be formed in portions other than the forming surface of the mold can be suppressed, thereby improving uniformity of the film thickness, optical characteristics, and the like of the film.

In addition, in a case of forming the film to be formed in the mold, it is preferable to use the holding device and the movable stage on which the mold is installed, thereby raising the stage so that the position of the forming surface of the mold is at a height approximately equal to the position of the film to be formed. In this way, the film to be formed comes into contact with the edge surface of the holding device, preventing the film from being greatly stretched.

The above-described holding device may be integrated with the above-described stage.

### <Method of Bonding Optical Film to Adherend>

A method of bonding the optical film to the adherend such as the lens is not particularly limited. For example, the optical film may be adhered to the adherend such as a lens using an adhesive or the like after being formed into a curved shape by any of the above-described methods.

In addition, from the viewpoint of simplifying the process, it is preferable to bond a pressure-sensitive adhesive sheet in advance to the surface of the optical film, which comes into contact with the mold, and to bond the pressure-sensitive adhesive sheet to the curved surface part of the mold simultaneously as the optical film is formed into a curved shape by the mold. That is, in this case, the adherend such as a lens is the mold (forming die).

### <Lens>

The lens according to the embodiment of the present invention is a composite lens including the optical film according to the embodiment of the present invention. In addition, the lens can include a lens base material consisting of glass or a transparent resin.

It is preferable that the lens base material does not change a polarization state of rays, and it is preferable that the phase difference (Re and Rth) is zero.

In addition, the lens may include a half mirror, an antireflection layer, an ultraviolet absorbing layer, a hard coat layer, or the like, in addition to the optical film according to the embodiment of the present invention.

A shape of the lens is not particularly limited, but it is preferable that at least one surface thereof is a curved surface. In a case where the lens has a curved surface, in the virtual reality display apparatus, aberration of the display image can be corrected to provide a higher quality display. In addition, the curved surface may be a part of a spherical surface or may be an aspherical surface. As the lens base material, a convex lens, a concave lens, a meniscus lens, or the like can be used. As the convex lens, a biconvex lens, a plano-convex lens, or a convex meniscus lens can be used. As the concave lens, a biconcave lens, a plano-concave lens, or a concave meniscus lens can be used.

### <Virtual Reality Display Apparatus>

The virtual reality display apparatus according to the embodiment of the present invention includes a lens including the optical film according to the embodiment of the present invention, and preferably includes an image display device and a lens including the optical film according to the embodiment of the present invention. As a result, the virtual reality display apparatus can suppress the occurrence of light leakage.

As the image display device, a display panel such as a liquid crystal display panel, an organic EL display panel, and a micro LED display panel can be used. In addition, the image display device may include an absorptive polarizer, a retardation layer, an antireflection layer, an ultraviolet absorbing layer, a hard coat layer, or the like.

In addition, the virtual reality display apparatus may include an additional optical member such as a lens for aberration correction and a diopter-adjustment lens. In addition, various sensors using near-infrared light as a light source, such as eye tracking, facial expression recognition, and iris authentication, may be mounted.

### <Image Display Device>

The virtual reality display apparatus according to the embodiment of the present invention includes an image display device.

As the image display device, an image display panel such as a liquid crystal display panel, an organic EL display panel, and a micro LED display panel can be used.

It is preferable that the image display device has an absorptive polarizer on a surface of the image display panel, and includes a retardation layer on an outer side, that is, a surface on a side from which light is emitted. As a result, the image display device can emit ideal circularly polarized light.

In addition, the image display device may include an antireflection layer, an ultraviolet absorbing layer, a hard coat layer, or the like, in addition to the above-described retardation layer.

The virtual reality display apparatus according to the embodiment of the present invention can be used as a headset such as a glasses type and a goggles type. In addition, the virtual reality display apparatus according to the embodiment of the present invention can be suitably used as an electronic view finder of a digital camera, an imager for a car-mounted display, and the like.

FIG. 7 conceptually shows an example of the virtual reality display apparatus according to the embodiment of the present invention. This example is a virtual reality display apparatus using a reflective linear polarizer.

A virtual reality display apparatus 20 shown in FIG. 7 includes an image display device and a pancake lens.

The image display device includes an image display panel 24, a λ/4 wavelength plate 26, an absorption type linear polarizer 28, and a λ/4 wavelength plate 30 in this order. Meanwhile, the pancake lens includes a half mirror 32, a lens base material 34, a λ/4 wavelength plate 36, a reflective linear polarizer 38, and an absorption type linear polarizer 40 in this order.

Here, the pancake lens is the lens according to the embodiment of the present invention. Therefore, in the pancake lens, one or more of the λ/4 wavelength plate 36, the reflective linear polarizer 38, and the absorption type linear polarizer 40 are the optical film according to the embodiment of the present invention, preferably two, and more preferably all are the optical film according to the embodiment of the present invention. In addition, in a case where two or more adjacent functional layers have the optical film, the optical film according to the embodiment of the present invention may be the above-described laminated optical body.

In the virtual reality display apparatus 20 shown in FIG. 7, an image (virtual reality image) emitted from the image display panel 24 is converted into linearly polarized light by the λ/4 wavelength plate 26, transmits through the absorption type linear polarizer 28 to become linearly polarized light in a predetermined direction, is converted into circularly polarized light by the λ/4 wavelength plate 30, and is emitted from the image display device. In the present example, as an example, the image display device emits dextrorotatory circularly polarized light R.

Half of the dextrorotatory circularly polarized light R emitted from the image display device transmits through the half mirror 32, transmits through the lens base material 34, and is converted into linearly polarized light by the λ/4 wavelength plate 36 in a direction reflected by the reflective linear polarizer 38.

Next, the linearly polarized light is reflected by the reflective linear polarizer 38, is converted into the dextrorotatory circularly polarized light R by the λ/4 wavelength plate 36, transmits through the lens base material 34, and is incident on the half mirror 32, and then half of the light is reflected by the half mirror 32. With the reflection, the dextrorotatory circularly polarized light R is converted into levorotatory circularly polarized light L.

The levorotatory circularly polarized light L reflected by the half mirror 32 transmits through the lens base material 34, and is converted into linearly polarized light by the λ/4 wavelength plate 36. Here, as described above, the λ/4 wavelength plate 36 converts the dextrorotatory circularly polarized light R into linearly polarized light in a direction reflected by the reflective linear polarizer 38. That is, the λ/4 wavelength plate 36 converts the levorotatory circularly polarized light L into linearly polarized light in a direction transmitted through the λ/4 wavelength plate 36.

Therefore, the linearly polarized light, that is, the virtual image transmits through the reflective linear polarizer 38 and the absorption type linear polarizer 40, and is observed by a user E.

In the virtual reality display apparatus 20, in a case where the linearly polarized light is incident on the reflective linear polarizer 38 first, light indicated by a broken line, which unnecessarily transmits through the reflective linear polarizer 38, is light leakage and is observed as a ghost by the user E.

On the other hand, in the virtual reality display apparatus 20, the pancake lens is the lens according to the embodiment of the present invention, using the optical film according to the embodiment of the present invention. That is, in the pancake lens, one or more, preferably all of the λ/4 wavelength plate 36, the reflective linear polarizer 38, and the absorption type linear polarizer 40 are the optical film according to the embodiment of the present invention.

As described above, the optical film according to the embodiment of the present invention has a small in-plane variation in optical characteristics and appropriately exhibits predetermined optical characteristics. That is, the λ/4 wavelength plate 36 appropriately converts the incident circularly polarized light into linearly polarized light, the reflective linear polarizer 38 appropriately reflects and transmits the predetermined linearly polarized light, and the absorption type linear polarizer 40 appropriately absorbs and transmits the predetermined linearly polarized light.

Therefore, the virtual reality display apparatus 20 according to the embodiment of the present invention can reduce the ghost observed by the user E by reducing the light leakage which unnecessarily transmits through the reflective linear polarizer 38.

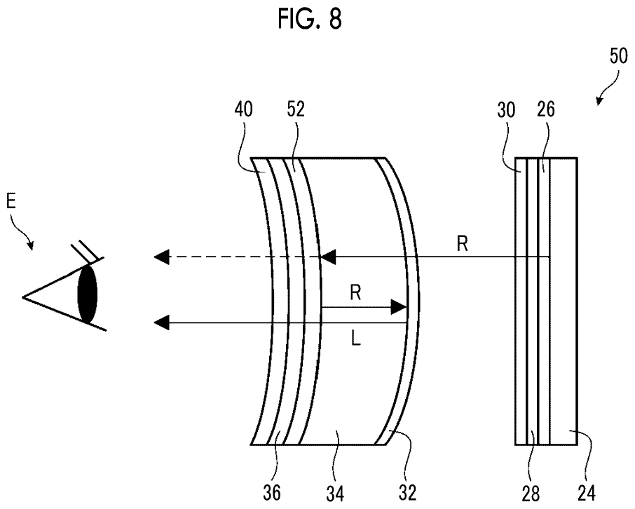

FIG. 8 conceptually shows an example of the virtual reality display apparatus according to the embodiment of the present invention. This example is a virtual reality display apparatus using a reflective circular polarizer.

In a virtual reality display apparatus 50 shown in FIG. 8, the same members as those of the virtual reality display apparatus 20 shown in FIG. 7 are used, and the same reference numerals are assigned to the same members, and the description will be mainly made for different parts.

The virtual reality display apparatus 50 shown in FIG. 8 includes an image display device and a pancake lens.

The image display device is the same as that of the virtual reality display apparatus 20 described above. Meanwhile, the pancake lens includes a half mirror 32, a lens base material 34, a reflective circular polarizer 52, a λ/4 wavelength plate 36, and an absorption type linear polarizer 40 in this order.

Here, the pancake lens is the lens according to the embodiment of the present invention. Therefore, in the pancake lens, one or more of the reflective circular polarizer 52, the λ/4 wavelength plate 36, and the absorption type linear polarizer 40 are the optical film according to the embodiment of the present invention, preferably two, and more preferably all are the optical film according to the embodiment of the present invention. In addition, in a case where two or more adjacent functional layers have the optical film, the optical film according to the embodiment of the present invention may be the above-described laminated optical body.

As in the previous example, in the virtual reality display apparatus 50 shown in FIG. 8, as an example, the image display device emits dextrorotatory circularly polarized light R.

Half of the dextrorotatory circularly polarized light R emitted from the image display device transmits through the half mirror 32, transmits through the lens base material 34, and is incident on the reflective circular polarizer 52.

In the present example, the reflective circular polarizer 52 reflects the dextrorotatory circularly polarized light R. Therefore, the dextrorotatory circularly polarized light R is reflected by the reflective circular polarizer 52, transmits through the lens base material 34, and is incident on the half mirror 32, and then half of the light is reflected by the half mirror 32. With the reflection, the dextrorotatory circularly polarized light R is converted into levorotatory circularly polarized light L.

The levorotatory circularly polarized light L reflected by the half mirror 32 transmits through the lens base material 34, and is incident on the reflective circular polarizer 52 again. As described above, since the reflective circular polarizer 52 reflects the dextrorotatory circularly polarized light R, the levorotatory circularly polarized light L transmits through the reflective circular polarizer 52.

The levorotatory circularly polarized light transmitted through the reflective circular polarizer 52 is converted into linearly polarized light by the λ/4 wavelength plate 36 in a direction passing through the absorption type linear polarizer 40, and is transmitted through the absorption type linear polarizer 40 and is observed by the user E.

In the virtual reality display apparatus 50, in a case where the dextrorotatory circularly polarized light R is incident on the reflective circular polarizer 52 first, light indicated by a broken line, which unnecessarily transmits through the reflective linear polarizer 38, is light leakage and is observed as a ghost by the user E.

On the other hand, in the virtual reality display apparatus 50, the pancake lens is the lens according to the embodiment of the present invention, using the optical film according to the embodiment of the present invention. That is, in the pancake lens, one or more, preferably all of the reflective circular polarizer 52, the λ/4 wavelength plate 36, and the absorption type linear polarizer 40 are the optical film according to the embodiment of the present invention.

Therefore, in the virtual reality display apparatus 50 shown in FIG. 8, the same action and effect as those of the virtual reality display device shown in FIG. 7 can be obtained, and the ghost observed by the user E can be reduced by reducing the light leakage which unnecessarily transmits through the reflective circular polarizer 52.

### Examples

Hereinafter, the features of the present invention will be described in more detail with reference to Examples. The materials, the used amounts, the proportions, the treatment contents, the treatment procedures, and the like described in Examples can be appropriately changed without departing from the gist of the present invention. In addition, configurations other than the configurations described below can be employed without departing from the gist of the present invention.

### [Production of Cellulose Acylate Film A1]

### (Production of Core Layer Cellulose Acylate Dope)

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution | 100 parts by mass |
| degree of 2.88 | |
| Polyester compound B described in Examples of | 12 parts by mass |
| JP2015-227955A | |
| Compound F shown below | 2 parts by mass |
| Methylene chloride (first solvent) | 430 parts by mass |
| Methanol (second solvent) | 64 parts by mass |

Compound F

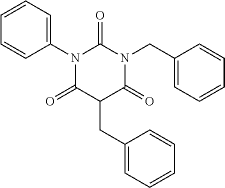 [SMILES: O=C1C(Cc2ccccc2)C(=O)N(c2ccccc2)C(=O)N1Cc1ccccc1]

### (Production of Outer Layer Cellulose Acylate Dope)

10 parts by mass of the following matting agent solution was added to 90 parts by mass of the core layer cellulose acylate dope to prepare a cellulose acetate solution to be used as an outer layer cellulose acylate dope.

Matting agent solution

| | | |
|---|---|---|
| Silica particles having an average particle | 2 | parts by mass |
| diameter of 20 nm (AEROSIL manufactured | | |
| by Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### (Production of Cellulose Acylate Film A1)

The above-described core layer cellulose acylate dope and the above-described outer layer cellulose acylate dope were filtered through a filter paper having an average hole diameter of 34 μm and a sintered metal filter having an average hole diameter of 10 μm. Thereafter, the core layer cellulose acylate dope and the outer layer cellulose acylate dopes on both sides thereof were cast simultaneously on a drum at 20° C. from a casting port in three layers (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction. Thereafter, the film was further dried by being transported between the rolls of the heat treatment device to prepare an optical film having a thickness of 40 μm, and the optical film was used as a cellulose acylate film A1. An in-plane phase difference of the obtained cellulose acylate film A1 was 0 nm.

### [Production of Retardation Film 1 Including Positive A-Plate]

The above-described cellulose acylate film A1 was continuously coated with a coating liquid E1 for forming a photo-alignment film, having the following formulation, with a wire bar. The support on which the coating film was formed was dried with hot air at 140° C. for 120 seconds. Next, the coating film was irradiated with polarized ultraviolet rays (10 mJ/cm², using an ultra-high pressure mercury lamp) to form a photo-alignment film E1 having a thickness of 0.2 μm, thereby obtaining a TAC film with a photo-alignment film.

Coating liquid E1 for forming photo-aligment film

| | |
|---|---|
| Polymer PA-2 shown below | 100.00 parts by mass |
| Acid generator PAG-1 shown below | 5.00 parts by mass |
| Acid generator CPI-110TF shown below | 0.005 parts by mass |
| Isopropyl alcohol | 16.50 parts by mass |
| Butyl acetate | 1072.00 parts by mass |
| Methyl ethyl ketone | 268.00 parts by mass |

Acid generator CPI-110TF 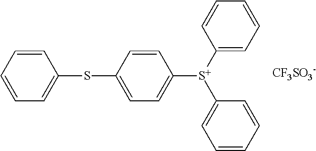
Polymer PA-2 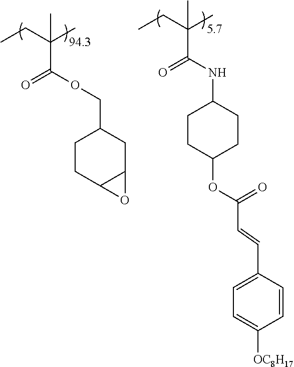
Acid generator PAG-1

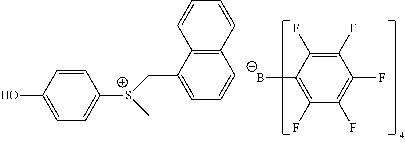

The above-described photo-alignment film E1 was coated with a composition F1 having the following formulation with a bar coater. The coating film formed on the photo-alignment film E1 was heated to 120° C. with hot air. Thereafter, the coating film was cooled to 60° C. and irradiated with ultraviolet rays at a wavelength of 365 nm and an intensity of 100 mJ/cm² using a high-pressure mercury lamp in a nitrogen atmosphere. Subsequently, the coating film was irradiated with ultraviolet rays at an intensity of 500 mJ/cm² while being heated to 120° C. to fix the alignment of the liquid crystal compound, thereby producing a retardation film 1 including a positive A-plate F1.

A thickness of the positive A-plate F1 was 2.5 μm, and Re(550) was 141 nm. In addition, the positive A-plate satisfied a relationship of Re(450)≤Re(550)≤Re(650), and had reverse wavelength dispersibility. Re(450)/Re(550) was 0.82.

Composition F1

| | |
|---|---|
| Polymerizable liquid crystal compound LA-1 shown below | 43.50 parts by mass |
| Polymerizable liquid crystal compound LA-2 shown below | 43.50 parts by mass |
| Polymerizable liquid crystal compound LA-3 shown below | 8.00 parts by mass |
| Polymerizable liquid crystal compound LA-4 shown below | 5.00 parts by mass |
| Polymerization initiator PI-1 shown below | 0.55 parts by mass |
| Leveling agent T-1 shown below | 0.20 parts by mass |
| Cyclopentanone | 235.00 parts by mass |

Polymerizable liquid crystal compound LA-1 (tBu represent a tertiary butyl group) 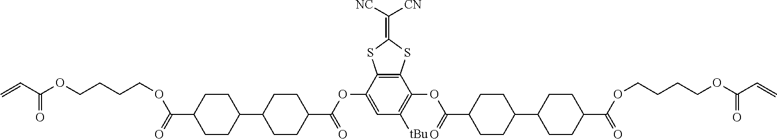 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]
Polymerizable liquid crystal compound LA-2 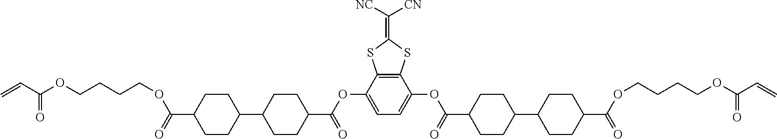 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Polymerizable liquid crystal compound LA-3 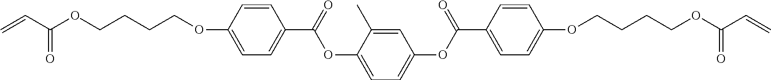 [SMILES: C=CC(=O)OCCCCOc1ccc(C(=O)Oc2ccc(OC(=O)c3ccc(OCCCCOC(=O)C=C)cc3)c(C)c2)cc1]
Polymerizable liquid crystal compound LA-4 (Me represents a methyl group) 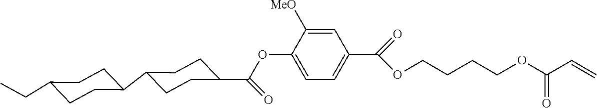 [SMILES: C=CC(=O)OCCCCOC(=O)c1ccc(OC(=O)C2CCC(C3CCC(CC)CC3)CC2)c(OC)c1]
Polymerization initiator PI-1 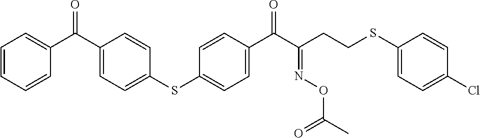 [SMILES: CC(=O)O/N=C(\CCSc1ccc(Cl)cc1)C(=O)c1ccc(Sc2ccc(C(=O)c3ccccc3)cc2)cc1]
Leveling agent T-1

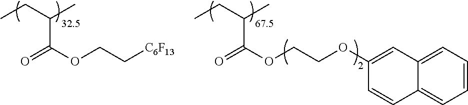

### [Production of Retardation Film 2]

An optically anisotropic layer coating liquid (A) having the following formulation was applied onto the above-described photo-alignment film E1 using a bar coater, and heated at 80° C. for 60 seconds. Thereafter, the film on which the coating film was formed was irradiated with light of a metal halide lamp (manufactured by Eye Graphics Co., Ltd.) at an irradiation amount of 500 mJ/cm² and at 80° C. in a nitrogen atmosphere to fix the alignment state of the liquid crystal compound, thereby producing a second optically anisotropic layer A2.

A product Δnd of Δn and d of the second optically anisotropic layer A2 at a wavelength of 550 nm was 194 nm, and a twisted angle was 85°. In addition, a molecular axis of the liquid crystal compound was horizontal to a surface of the cellulose acylate film (or a surface of the optically anisotropic layer).

### Formulation of Optically Anisotropic Layer Coating Liquid (A)

| | |
|---|---|
| Rod-like liquid crystal compound (A) shown below | 40 parts by mass |
| Rod-like liquid crystal compound (B) shown below | 40 parts by mass |
| Rod-like liquid crystal compound (C) shown below | 20 parts by mass |
| Ethylene oxide-modified trimethylolpropane triacrylate (V#360, manufactured by Osaka | 4 parts by mass |
| Organic Chemical Industry Ltd.) | |
| Photopolymerization initiator (IRGACURE 819, manufactured by Chiba Japan Co., Ltd.) | 3 parts by mass |
| Chiral agent (A) shown below | 0.46 parts by mass |
| Polymerizable polymer (X) shown below | 0.5 parts by mass |
| Polymer (A) shown below | 0.1 parts by mass |
| Methyl isobutyl ketone | 325 parts by mass |

Rod-like liquid crystal compound (A) 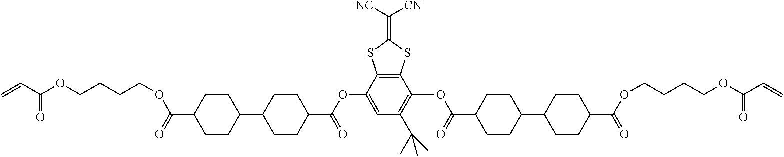 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]
Rod-like liquid crystal compound (B) 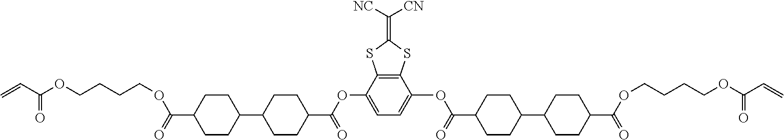 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Rod-like liquid crystal compound (C) (corresponds to a mixture of liquid crystal compounds shown below) 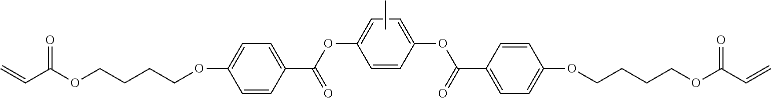 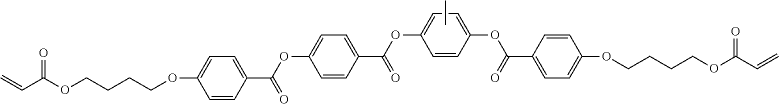 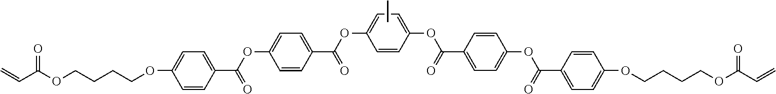
Chiral agent (A) 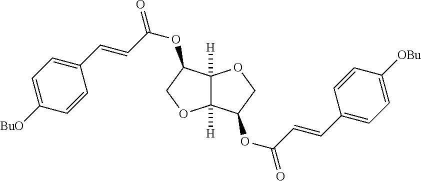
Polymerizable polymer (X) 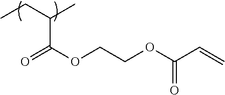
Polymer (A)

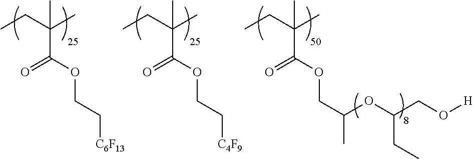

Next, a coating liquid in which the chiral agent (A) was removed from the above-described optically anisotropic layer coating liquid (A) was applied onto the above-described second optically anisotropic layer A2 using a bar coater, and heated at 80° C. for 60 seconds. Thereafter, the film on which the coating film was formed was irradiated with light of a metal halide lamp (manufactured by Eye Graphics Co., Ltd.) at an irradiation amount of 500 mJ/cm² and at 80° C. in a nitrogen atmosphere to fix the alignment state of the liquid crystal compound, thereby producing a first optically anisotropic layer A1.

The first optically anisotropic layer A1 was a positive A-plate in which a product Δnd of Δn and d at a wavelength of 550 nm was 205 nm, and an orientation of the slow axis was the same as the orientation of the uppermost layer of the second optically anisotropic layer A2.

In this way, a retardation film 2 was produced.

An effective in-plane phase difference of the retardation film 2 was a value in a range of λ/4±5% in a wavelength range of λ of 450 nm to 650 nm.

### [Production of Retardation Film 3]

A retardation film 3 was produced in the same manner as in the retardation film 2, except that the film thickness of the optically anisotropic layer and the amount of the chiral agent (A) contained in the optically anisotropic layer were adjusted.

A product Δnd of Δn and d of the second optically anisotropic layer in the retardation film 3 at a wavelength of 550 nm was 157 nm, and a twisted angle was 81°. In addition, a product Δnd of Δn and d of the first optically anisotropic layer at a wavelength of 550 nm was 310 nm, and a twisted angle was 24°.

An effective in-plane phase difference of the retardation film 3 was a value in a range of/4±5% in a wavelength range of λ of 450 nm to 650 nm.

### [Production of Positive C-Plate]

The above-described cellulose acylate film A1 was used as a temporary support.

The cellulose acylate film A1 was passed through a dielectric heating roll at a temperature of 60° C. to raise a surface temperature of the film to 40° C. Thereafter, an alkaline solution having the following formulation was applied onto one surface of the film at an application amount of 14 ml/m² using a bar coater, heated to 110° C., and then transported for 10 seconds under a steam type far-infrared heater manufactured by Noritake Company Limited.

Next, the film was coated with pure water such that the coating amount reached 3 ml/m² using the same bar coater. Next, the film was washed with water by a fountain coater and drained by an air knife three times, and then transported to a drying zone at 70° C. for 10 seconds and dried to produce a cellulose acylate film A1 subjected to an alkali saponification treatment.

(Alkaline solution)

| Potassium hydroxide | 4.7 | parts by mass |
|---|---|---|
| Water | 15.8 | parts by mass |
| Isopropanol | 63.7 | parts by mass |
| Fluorine-containing surfactant | 1.0 | part by mass |
| SF-1 (C₁₄H₂₉O(CH₂CH₂O)₂₀H) | | |
| Propylene glycol | 14.8 | parts by mass |

The cellulose acylate film A1 which had been subjected to the alkali saponification treatment was continuously coated with a coating liquid G1 for forming an alignment film, having the following formulation, using a #8 wire bar. The obtained film was dried with hot air at 60° C. for 60 seconds, and further dried with hot air at 100° C. for 120 seconds to form an alignment film G1.

Coating liquid G1 for forming alignment film

| | | |
|---|---|---|
| Polyvinyl alcohol (PVA103 | 2.4 | parts by mass |
| manufactured by Kuraray Co., Ltd.) | | |
| Isopropyl alcohol | 1.6 | parts by mass |
| Methanol | 36 | parts by mass |
| Water | 60 | parts by mass |

The alignment film G1 was coated with a coating liquid H1 for forming a positive C plate, having the following formulation, the obtained coating film was aged at 60° C. for 60 seconds and irradiated with ultraviolet rays at an illuminance of 1000 mJ/cm² in the air using an air-cooled metal halide lamp at an illuminance of 70 mW/cm² (manufactured by Eye Graphics Co., Ltd.), and the alignment state thereof was fixed to vertically align the liquid crystal compound, thereby producing a positive C-plate having a thickness of 0.8 μm.

Rth(550) of the obtained positive C-plate was −80 nm.

Coating liquid H1 for forming positive C-plate

| | |
|---|---|
| Liquid crystal compound LC-1 shown below | 80 parts by mass |
| Liquid crystal compound LC-2 shown below | 20 parts by mass |
| Vertical alignment agent S01 shown below | 1 part by mass |
| Ethylene oxide-modified trimethylolpropane triacrylate (V#360, manufactured by Osaka Organic Chemical | 8 parts by mass |
| Industry Ltd.) | |
| IRGACURE 907 (manufactured by BASF SE) | 3 parts by mass |
| KAYACURE DETX (manufactured by Nippon Kayaku Co., Ltd.) | 1 part by mass |
| Compound B03 shown below | 0.4 parts by mass |
| Methyl ethyl ketone | 170 parts by mass |
| Cyclohexanone | 30 parts by mass |

Liquid crystal compound LC-1 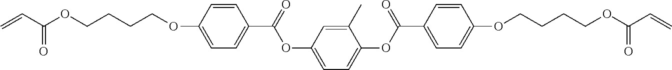 [SMILES: C=CC(=O)OCCCCOc1ccc(C(=O)Oc2ccc(OC(=O)c3ccc(OCCCCOC(=O)C=C)cc3)c(C)c2)cc1]
Liquid crystal compound LC-2 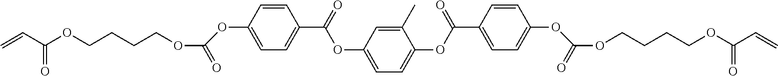 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]
Vertical alignment agent S01 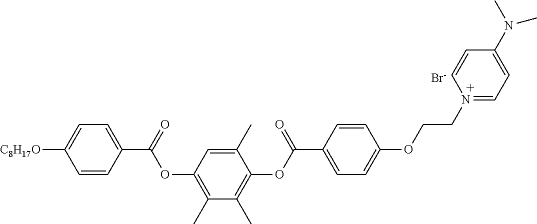
Compound B03

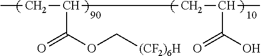

### [Production of Absorption Type Linear Polarizer]

### <Formation of Photo-Alignment Layer PA1>

The above-described cellulose acylate film A1 was used as a temporary support.

The above-described cellulose acylate film A1 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment layer PAL. A film thickness thereof was 0.3 μm.

(Coating liquid S-PA-1 for forming alignment layer)

| | |
|---|---|
| Polymer M-PA-1 shown below | 100.00 parts by mass |
| Acid generator PAG-1 shown below | 5.00 parts by mass |
| Acid generator CPI-110TF shown below | 0.005 parts by mass |
| Xylene | 1220.00 parts by mass |
| Methyl isobutyl ketone | 122.00 parts by mass |

Polymer M-PA-1 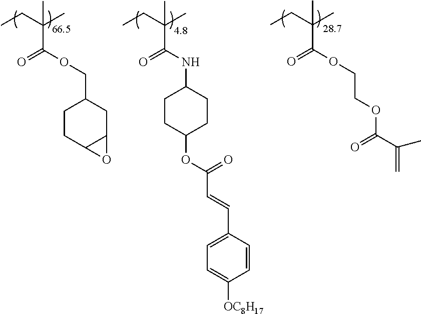
Acid generator PAG-1 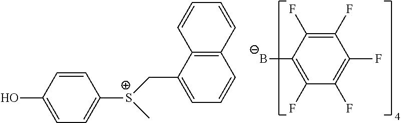
Acid generator CPI-110TF

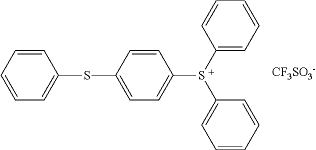

### <Formation of Light-Absorbing Anisotropic Layer>

The obtained photo-alignment layer PA1 was continuously coated with the following coating liquid S-P-1 for forming a light-absorbing anisotropic layer with a wire bar. Next, the coating layer P1 was heated at 140° C. for 30 seconds and cooled to room temperature (23° C.). Next, the coating layer P1 was heated at 90° C. for 60 seconds and cooled to room temperature again. Thereafter, the coating layer was irradiated with an LED lamp (central wavelength of 365 nm) for 2 seconds under an irradiation condition of an illuminance of 200 mW/cm², thereby forming a light-absorbing anisotropic layer on the photo-alignment layer PA1. A film thickness thereof was 1.6 μm.

In this way, an absorption type linear polarizer P1 was produced.

Composition of coating liquid S-P-1 for forming light-absorbing anisotropic layer

| | |
|---|---|
| Dichroic substance D-1 shown below | 0.25 parts by mass |
| Dichroic substance D-2 shown below | 0.36 parts by mass |
| Dichroic substance D-3 shown below | 0.59 parts by mass |
| High molecular-weight liquid crystal compound M-P-1 shown below | 2.21 parts by mass |
| Low-molecular-weight liquid crystal compound M-1 | 1.36 parts by mass |
| Polymerization initiator: IRGACURE OXE-02 (manufactured by BASF) | 0.200 parts by mass |
| Surfactant F-1 shown below | 0.026 parts by mass |
| Cyclopentanone | 46.00 parts by mass |
| Tetrahydrofuran | 46.00 parts by mass |
| Benzyl alcohol | 3.00 parts by mass |

Dichroic substance D-1 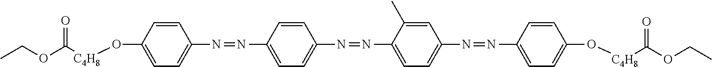
Dichroic substance D-2 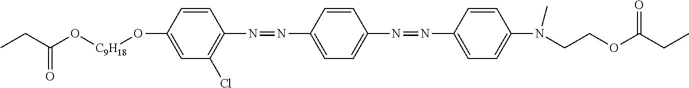
Dichroic substance D-3 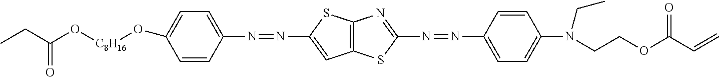
High-molecular-weight liquid crystal compound M-P-1 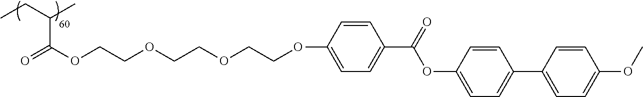 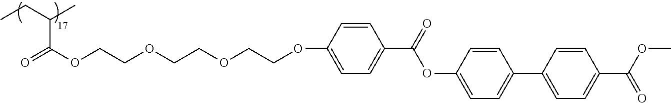 [SMILES: CCC(C)C(=O)OCCOCCOCCOc1ccc(C(=O)Oc2ccc(-c3ccc(C(=O)OC)cc3)cc2)cc1] 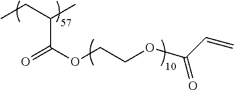
Low-molecular-weight liquid crystalline compound M-1 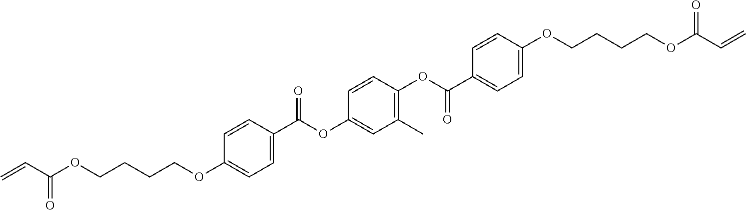 [SMILES: C=CC(=O)OCCCCOc1ccc(C(=O)Oc2ccc(OC(=O)c3ccc(OCCCCOC(=O)C=C)cc3)c(C)c2)cc1]
Surfactant F-1

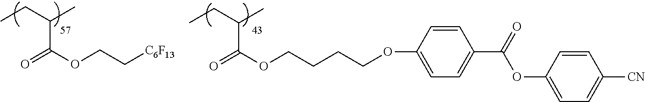

### [Production of Retardation Film 4]

A retardation film 4 was produced in the same manner as in the retardation film 2, except that the optically anisotropic layer coating liquid (A) was changed to the following optically anisotropic layer coating liquid (B).

### Formulation of Optically Anisotropic Layer Coating Liquid (B)

| | |
|---|---|
| Liquid crystal compound L-1 shown below | 70 parts by mass |
| Liquid crystal compound L-2 shown below | 30 parts by mass |
| Polymerization initiator S-1 shown below | 0.6 parts by mass |
| Ethylene oxide-modified trimethylolpropane triacrylate (V#360, manufactured by Osaka Organic Chemical Industry Ltd.) | 4 parts by mass |
| Photopolymerization initiator (IRGACURE 819, manufactured by Chiba Japan Co., Ltd.) | 3 parts by mass |
| Chiral agent (A) shown below | 0.46 parts by mass |
| Polymerization polymer (X) shown above | 0.5 parts by mass |
| Polymer (A) shown above | 0.1 parts by mass |
| Methyl ethyl ketone | 200 parts by mass |
| Cyclopentanone | 200 parts by mass |

Liquid crystal compound L-1 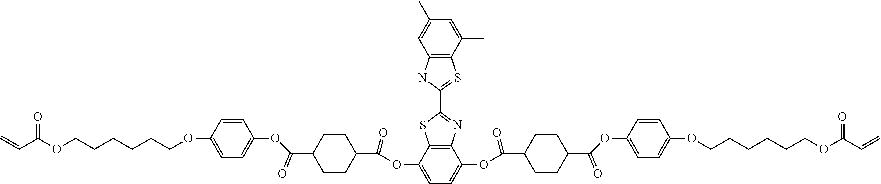
Liquid crystal compound L-2 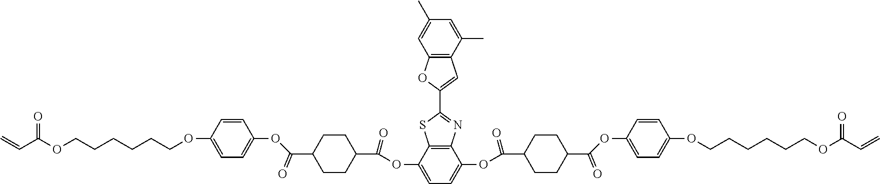 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c4sc(-c5cc6c(C)cc(C)cc6o5)nc34)CC2)cc1]
Polymerization initiator S-1

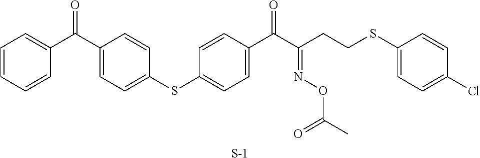

In the produced retardation film 4, the first optically anisotropic layer was a positive A-plate in which a product Δnd of Δn and d at a wavelength of 550 nm was 203 nm, and an orientation of the slow axis was the same as the orientation of the uppermost layer of the second optically anisotropic layer. In addition, a product Δnd of Δn and d of the second optically anisotropic layer at a wavelength of 550 nm was 196 nm, and a twisted angle was 850.

In addition, an effective in-plane phase difference of the retardation film 4 was a value in a range of λ/4±5% in a wavelength range of λ of 450 nm to 650 nm.

### [Production of Reflective Circular Polarizer 1]

### [Preparation of Coating Liquid for Reflective Layer]

### <Coating Liquid R-1 for Reflective Layer>

A composition shown below was stirred and dissolved in a container held at 70° C. to prepare a coating liquid R-1 for a reflecting layer. Here, R represents a coating liquid containing a rod-like liquid crystal compound.

Coating liquid R-1 for reflecting layer

| | |
|---|---|
| Methyl ethyl ketone | 120.9 parts by mass |
| Cyclohexanone | 21.3 parts by mass |
| Mixture X of rod-like liquid crystal compounds shown below | 100.0 parts by mass |
| Photopolymerization initiator B shown below | 1.00 part by mass |
| Chiral agent A shown below | 4.18 parts by mass |
| Surfactant F1 shown below | 0.1 parts by mass |

Mixture X of rod-like crystal compounds

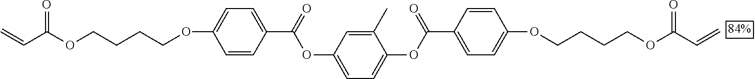 [SMILES: C=CC(=O)OCCCCOc1ccc(C(=O)Oc2ccc(OC(=O)c3ccc(OCCCCOC(=O)C=C)cc3)c(C)c2)cc1]

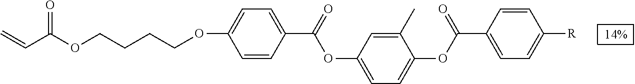

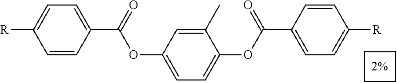

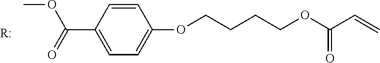

In the above-described mixture X, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol cm.

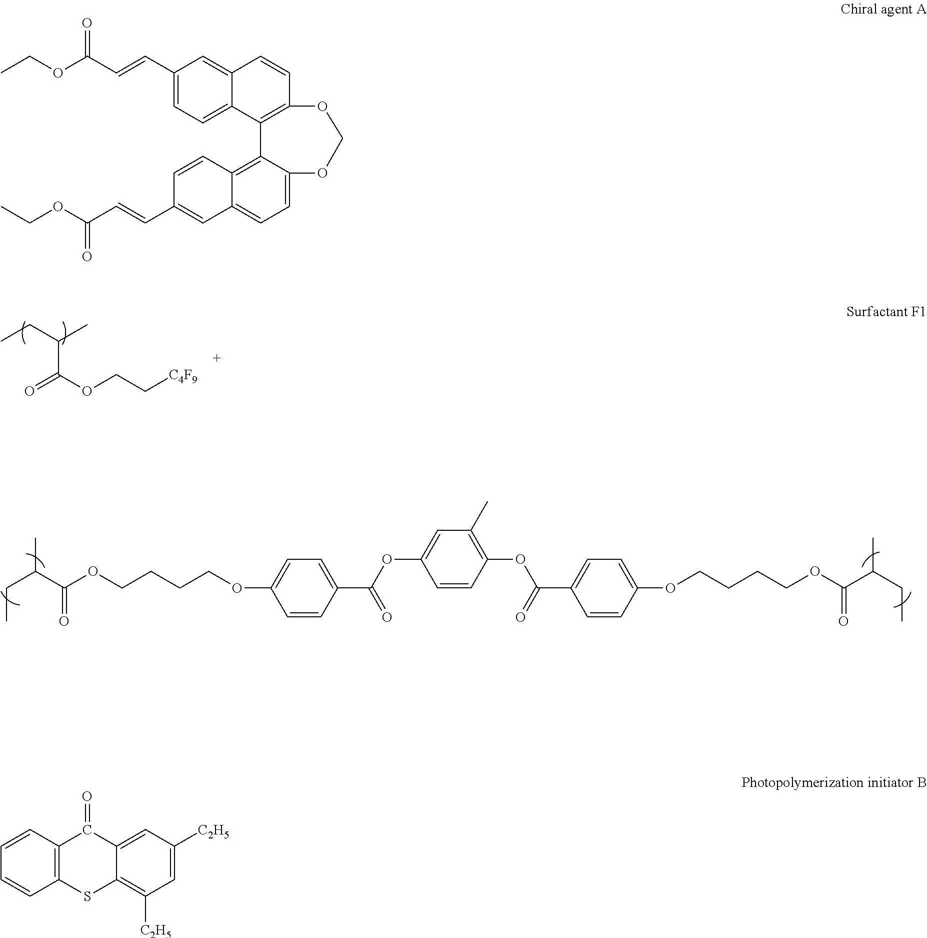

The chiral agent A is a chiral agent in which the helical twisting power (HTP) is reduced by light.

### <Coating Liquid R-2 for Reflective Layer>

A coating liquid was prepared in the same manner as in the coating liquid R-1 for a reflecting layer, except that the amount of the chiral agent A added was changed as shown in Table 1.

TABLE 1

| | Amount of |
|---|---|
| Coating liquid | chiral agent |
| name | (part by mass) |
| Liquid R-1 | 4.18 |
| Liquid R-2 | 3.00 |

### <Coating Liquid D-1 for Reflective Layer>

A composition shown below was stirred and dissolved in a container held at 50° C. to prepare a coating liquid D-1 for a reflecting layer. Here, D represents a coating liquid containing a disk-like liquid crystal compound.

Coating liquid D-1 for reflecting layer

| | |
|---|---|
| Disk-like liquid crystal compound (A) shown below | 80 parts by mass |
| Disk-like liquid crystal compound (B) shown below | 20 parts by mass |
| Polymerizable monomer E1 shown below | 10 parts by mass |
| Surfactant F2 shown below | 0.3 parts by mass |
| Photopolymerization initiator (IRGACURE 907 manufactured by BASF SE) | 3 parts by mass |
| Chiral agent A shown above | 5.45 parts by mass |
| Methyl ethyl ketone | 290 parts by mass |
| Cyclohexanone | 50 parts by mass |

Disk-like liquid crystal compound (A) 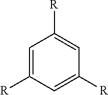 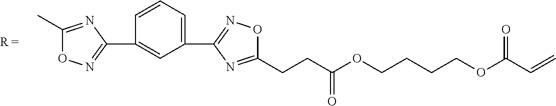 [SMILES: C=CC(=O)OCCCCOC(=O)CCc1nc(-c2cccc(-c3noc(C)n3)c2)no1]
Disk-like liquid crystal compound (B) 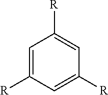 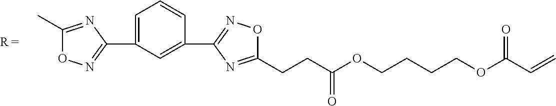 [SMILES: C=CC(=O)OCCCCOC(=O)CCc1nc(-c2cccc(-c3noc(C)n3)c2)no1]
Polymerizable monomer E1 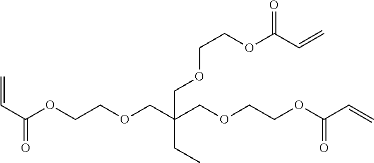 [SMILES: C=CC(=O)OCCOCC(CC)(COCCOC(=O)C=C)COCCOC(=O)C=C]
Surfactant F2

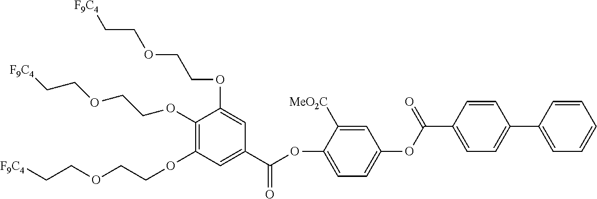

### <Coating Liquids D-2 and D-3 for Reflective Layer>

Coating liquids D-2 and D-3 for a reflective layer was prepared in the same manner as in the coating liquid D-1 for a reflective layer, except that the amount of the chiral agent A added was changed as shown in Table 2.

TABLE 2

| | Amount of chiral agent |
|---|---|
| Coating liquid name | (part by mass) |
| Liquid D-1 | 5.45 |
| Liquid D-2 | 4.52 |
| Liquid D-3 | 4.10 |

### <<Production of Reflective Circular Polarizer 1>>

A PET film (manufactured by TOYOBO Co., Ltd., A4265) having a thickness of 100 m was prepared as a temporary support, and a PET surface on a side where an easy adhesive layer was not formed was rubbed.

The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a first blue light reflective layer consisting of a cholesteric liquid crystal layer (first cholesteric liquid crystal layer). The irradiation with light was carried out from the side of the cholesteric liquid crystal layer. Here, the thickness of the coating was adjusted so that the film thickness of the cured first blue light reflective layer was 2.6 μm.

Next, the surface of the first blue light reflective layer was subjected to a corona treatment at a discharge amount of 150 W·min/m², and the surface subjected to the corona treatment was coated with the coating liquid D-1 for a reflecting layer using a wire bar coater.

Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflective layer (second cholesteric liquid crystal layer) on the first blue light reflective layer. The irradiation with light was carried out from the side of the cholesteric liquid crystal layer. Here, the coating thickness was adjusted so that the film thickness of the cured second blue light reflective layer was 2.0 μm.

Next, the second blue light reflective layer was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a green light reflective layer (third cholesteric liquid crystal layer) on the second blue light reflective layer. The irradiation with light was carried out from the side of the cholesteric liquid crystal layer. Here, the coating thickness was adjusted so that the film thickness of the cured green light reflective layer was 2.7 μm.

Next, the green light reflective layer was coated with the coating liquid R-2 for a reflecting layer using a wire bar coater and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflective layer (fourth cholesteric liquid crystal layer) on the green light reflective layer. The irradiation with light was carried out from the side of the cholesteric liquid crystal layer. Here, the coating thickness was adjusted so that the film thickness of the cured red light reflective layer was 3.4 μm.

Next, the surface of the red light reflective layer was subjected to a corona treatment at a discharge amount of 150 W·min/m², and the surface subjected to the corona treatment was coated with the coating liquid D-3 for a reflecting layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a yellow light reflective layer (fifth cholesteric liquid crystal layer) on the red light reflective layer. The irradiation with light was carried out from the side of the cholesteric liquid crystal layer. Here, the coating thickness was adjusted so that the film thickness of the cured yellow light reflective layer was 3.4 μm.

By the above procedure, a reflective circular polarizer 1 including the first cholesteric liquid crystal layer to the fifth cholesteric liquid crystal layer in this order was obtained.

For each cholesteric liquid crystal layer of the produced reflective circular polarizer 1, a reflection center wavelength and a film thickness are shown in Table 3. Here, the reflection center wavelength shown in Table 3 corresponds to a central wavelength of the reflected light of the above-described cholesteric liquid crystal layer. The reflection center wavelength (central wavelength of the reflected light) was confirmed by producing a film of each cholesteric liquid crystal layer, obtained by applying only a single layer. The film thickness was obtained by SEM.

TABLE 3

| | | Reflection center | |
|---|---|---|---|
| | Type of coating | wavelength | Film thickness |
| | liquid | (nm) | (μm) |
| Fifth layer | Liquid D-3 | 586 | 3.4 |
| Fourth layer | Liquid R-2 | 661 | 3.4 |
| Third layer | Liquid D-2 | 531 | 2.7 |
| Second | Liquid D-1 | 441 | 2.0 |
| layer | | | |
| First layer | Liquid R-1 | 475 | 2.6 |

In addition, in a case where the temporary support of the obtained reflective circular polarizer 1 was peeled off and SHG measurement of the surface of the first cholesteric liquid crystal layer was carried out, an alignment degree of the liquid crystal compound was 0.65. In addition, in a case of being incorporated into a virtual reality display apparatus, a variation in director orientation of the liquid crystal compound in the effective region was 3.2°.

In addition, in a case where the SHG measurement of the surface of the reflective circular polarizer 1 on the fifth cholesteric liquid crystal layer side was carried out, an alignment degree of the liquid crystal compound was 0.62. In addition, in a case of being incorporated into a virtual reality display apparatus, a variation in director orientation of the liquid crystal compound in the effective region was 85°.

### [Production of Laminated Optical Body 1]

A liquid crystal display of a tablet computer “iPad (registered trademark)” manufactured by Apple Inc. was taken out, and a linear polarization type reflective polarizer (APF, trademark name of 3M Company) consisting of a broadband dielectric multi-layer film was peeled off from a polarizing plate bonded to a back surface of the liquid crystal display.

Next, the retardation film 1 was bonded to one surface of the peeled APF using a pressure-sensitive adhesive sheet “NCF-D692 (5)” manufactured by LINTEC Corporation, and the temporary support of the retardation film 1 was peeled off. In this case, an orientation of a reflection axis of the APF was adjusted to be 75° with respect to the orientation of the slow axis of the retardation film 1.

Next, the second retardation film 1 was bonded to the first retardation film 1 such that the orientations of the slow axes matched, and then the temporary support was peeled off.

Next, the third retardation film 1 was bonded to the second retardation film 1 such that the orientations of the slow axes had an angle of 60°, and then the temporary support was peeled off. In this case, the orientation of the reflection axis of the APF was 15° with respect to the orientation of the slow axis of the third retardation film.

In addition, the above-described positive C-plate was bonded to the third retardation film 1, and then the temporary support was peeled off.

Furthermore, the absorption type linear polarizer P1 was bonded to the surface opposite to the APF, and then the temporary support was peeled off. In this case, the orientation of the reflection axis of the APF and the orientation of the absorption axis of the absorption type linear polarizer P1 were adjusted to match.

In this way, a laminated optical body 1 was obtained.

In the laminated optical body 1, since the first retardation film 1 and the second retardation film 1 among the laminated three retardation films 1 had the same orientation of the slow axis, these can be collectively regarded as the first optically anisotropic layer. In addition, the third retardation film 1 can be regarded as the second optically anisotropic layer. In this case, the first optically anisotropic layer had an in-plane phase difference of 282 nm, and the second optically anisotropic layer had an in-plane phase difference of 141 nm.

In addition, both the first optically anisotropic layer and the second optically anisotropic layer had reverse wavelength dispersibility.

### [Production of Laminated Optical Body 2]

A liquid crystal display of a tablet computer “iPad (registered trademark)” manufactured by Apple Inc. was taken out, and a linear polarization type reflective polarizer (APF, trademark name of 3M Company) consisting of a broadband dielectric multi-layer film was peeled off from a polarizing plate bonded to a back surface of the liquid crystal display.

Next, the retardation film 1 was bonded to one surface of the peeled APF using a pressure-sensitive adhesive sheet “NCF-D692 (5)” manufactured by LINTEC Corporation, and the temporary support of the retardation film 1 was peeled off. In this case, an orientation of a reflection axis of the APF was adjusted to be 45° with respect to the orientation of the slow axis of the retardation film 1.

Furthermore, the absorption type linear polarizer P1 was bonded to the surface opposite to the APF, and then the temporary support was peeled off. In this case, the orientation of the reflection axis of the APF and the orientation of the absorption axis of the absorption type linear polarizer P1 were adjusted to match.

In this way, a laminated optical body 2 was obtained.

### [Production of Laminated Optical Body 3]

A laminated optical body 3 was produced in the same manner as in the laminated optical body 2, except that the retardation film 1 was changed to the retardation film 2.

### [Production of Laminated Optical Body 4]

A laminated optical body 4 was produced in the same manner as in the laminated optical body 2, except that the retardation film 1 was changed to the retardation film 3.

### [Production of Laminated Optical Body 5]

A laminated optical body 5 was produced in the same manner as in the laminated optical body 2, except that the retardation film 1 was changed to the retardation film 4.

### [Production of Laminated Optical Body 6]

The absorption type linear polarizer P1 was bonded to a PMMA film “TECHNOLLOY S001G” manufactured by Sumika Acryl Co., Ltd. using a pressure-sensitive adhesive sheet “NCF-D692 (5)” manufactured by LINTEC Corporation, and the temporary support was peeled off.

Next, the retardation film 1 was bonded to the surface of the absorption type linear polarizer P1 using a pressure-sensitive adhesive sheet “NCF-D692 (5)” manufactured by LINTEC Corporation, and the temporary support was peeled off. In this case, an orientation of an absorption axis of the absorption type linear polarizer P1 was adjusted to be 45° with respect to the orientation of the slow axis of the retardation film 1.

Next, the reflective circular polarizer 1 was bonded to the surface of the retardation film 1 using a pressure-sensitive adhesive sheet “NCF-D692 (5)” manufactured by LINTEC Corporation, and the temporary support was peeled off.

In this way, a laminated optical body 6 was obtained.

### [Production of Optical Film 1]

### <Forming Method 1>

The laminated optical body 1 was set in a forming device.

A forming space in the forming device consisted of a box 1 and a box 2, partitioned by the laminated optical body 1, and a convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold in the box 1 on the lower side of the laminated optical body 1, with the concave surface facing upward.

In addition, a transparent window was installed on the upper part of the box 2 on the upper side of the laminated optical body 1, and an IR light source for heating the laminated optical body 1 was installed on the outside of the forming device.

Between the IR light source and the laminated optical body 1, a cholesteric liquid crystal layer which reflects infrared rays with wavelengths from 2.2 μm to 3.0 μm at a reflectivity of approximately 50% was cut into a circular shape having a diameter of 1 inch, and a circular patterned infrared reflecting filter was disposed. In this case, the center portion of the patterned infrared reflecting filter was disposed to be located at the center portion of the mold in a case of being viewed from directly above.

Next, each of the inside of box 1 and the inside of box 2 was evacuated to 0.1 atm or less by a vacuum pump.

Next, as a step of heating the laminated optical body 1, the laminated optical body 1 was irradiated with infrared rays and heated until the central portion of the laminated optical body 1 reached 108° C. and the end portion thereof reached 99° C. Since the glass transition temperature Tg of the PMMA film used as the support was 105° C., it was intended that the center portion would be more likely to stretch and the end part would be less likely to stretch during the forming. Next, as a step of pressing the laminated optical body 1 against the mold to the laminated optical body 1 along a shape of the mold, gas was allowed to flow into the box 2 from a gas cylinder to pressurize the optical film to 300 kPa, and the laminated optical body 1 was pressed against the mold. Finally, the laminated optical body 1 was removed from the mold which was a lens. In this way, an optical film 1 was obtained.

The optical film 1 had a curved surface having a curvature radius of 65 mm. In addition, in a case where a surface area of the curved surface was measured by a Fizeau interferometer (manufactured by FUJIFILM Corporation), the surface area was 2111 mm². On the other hand, a projected area of the curved surface, that is, a projected area of the curved surface projected onto a plane perpendicular to the optical axis was 2027 mm². Therefore, a ratio R1 of the surface area of the curved surface to the projected area of the curved surface was 1.041. Accordingly, R1−1 was 0.041.

In a total of 33 points, the thickness of the optical film on the curved surface was measured by the above-described method with reference to FIG. 5. As a result, the maximum thickness t_max1 was located at the end part of the curved surface and was 53 μm, and the minimum thickness t_min1 was located at the position of the optical axis (bottom) and was 49 μm.

Therefore, (t_max1−t_min1)/t_min1=0.082, which satisfied (t_max−t_min)/t_min>R− 1.

In the obtained optical film 1, a ratio t11/t21 of a thickness t11 of the first optically anisotropic layer to a thickness t21 of the second optically anisotropic layer had a maximum variation of 3% in the plane. As a result, the variation in effective in-plane phase difference of the optical film 1 was 4%.

In addition, the variation in orientation of the slow axis of the first optically anisotropic layer projected onto a plane perpendicular to the curved surface was a maximum of 1.1° in the plane. Furthermore, the variation in orientation of the slow axis of the second optically anisotropic layer projected onto a plane perpendicular to the curved surface was a maximum of 1.2° in the plane. As a result, the variation in orientation of the effective slow axis of the optical film 1 projected onto the plane perpendicular to the curved surface was 1.3°.

The position at which the in-plane variation was measured was a position corresponding to the intersection of the pattern shown in FIG. 5, and a total of 17 points including a center point, a circle at an interval of a radius of 10 mm in the diameter direction, and an intersection of straight lines at an interval of 45 degrees in the azimuthal direction were measured. The in-plane variation was calculated from the average value, the maximum value, and the minimum value of these 17 points. The same applies to Examples below.

### [Production of Optical Film 2]

The forming was carried out in the same manner as in the optical film 1, except that the laminated optical body 1 was changed to the laminated optical body 2. In this way, an optical film 2 was obtained.

The optical film 2 had a curved surface having a curvature radius of 65 mm.

In a case where the measurement was carried out in the same manner as in the optical film 1, the surface area of the curved surface of the optical film 2 was 2111 mm². In addition, the projected area of the curved surface was 2027 mm². Therefore, a ratio R2 of the surface area of the curved surface to the projected area of the curved surface was 1.041. Accordingly, R2−1 was 0.041.

In a case where the thickness of the curved surface of the optical film 2 was measured in the same manner as in the optical film 1, the maximum thickness t_max2 was located at the end part of the curved surface and was 32 μm, and the minimum thickness t_min2 was located at the position of the optical axis and was 29.6 μm.

Therefore, (t_max2−t_min2)/t_min2=0.081, which satisfied (t_max−t_min)/t_min>R−1.

### [Production of Optical Film 3]

The forming was carried out in the same manner as in the optical film 1, except that the laminated optical body 1 was changed to the laminated optical body 3. In this way, an optical film 3 was obtained.

The optical film 3 had a curved surface having a curvature radius of 65 mm.

In a case where the measurement was carried out in the same manner as in the optical film 1, the surface area of the curved surface of the optical film 3 was 2111 mm². In addition, the projected area of the curved surface was 2027 mm². Therefore, a ratio R3 of the surface area of the curved surface to the projected area of the curved surface was 1.041. Accordingly, R3−1 was 0.041.

In a case where the thickness of the curved surface of the optical film 3 was measured in the same manner as in the optical film 1, the maximum thickness t_max3 was located at the end part of the curved surface and was 34 μm, and the minimum thickness t_min3 was located at the position of the optical axis and was 31.4 μm.

Therefore, (t_max3−t_min3)/t_min3=0.083, which satisfied (t_max−t_min)/t_min>R− 1.

In the obtained optical film 3, a ratio t13/t23 of a thickness t13 of the first optically anisotropic layer to a thickness t23 of the second optically anisotropic layer had a maximum variation of 2% in the plane. As a result, the variation in effective in-plane phase difference of the optical film 3 was 3%.

In addition, the variation in orientation of the effective slow axis of the optical film 3 projected onto the plane perpendicular to the curved surface was 1.2°.

### [Production of Optical Film 4]

The forming was carried out in the same manner as in the optical film 1, except that the laminated optical body 1 was changed to the laminated optical body 4. In this way, an optical film 4 was obtained.

The optical film 4 had a curved surface having a curvature radius of 65 mm. In a case where the measurement was carried out in the same manner as in the optical film 1, the surface area of the curved surface of the optical film 4 was 2111 mm². In addition, the projected area of the curved surface was 2027 mm². Therefore, a ratio R4 of the surface area of the curved surface to the projected area of the curved surface was 1.041. Accordingly, R4−1 was 0.041.

In a case where the thickness of the curved surface of the optical film 4 was measured in the same manner as in the optical film 1, the maximum thickness t_max4 was located at the end part of the curved surface and was 34 μm, and the minimum thickness t_min4 was located at the position of the optical axis and was 31.4 μm.

Therefore, (t_max4−t_min4)/t_min4=0.083, which satisfied (t_max−t_min)/t_min>R− 1.

In the obtained optical film 4, a ratio t14/t24 of a thickness t14 of the first optically anisotropic layer to a thickness t24 of the second optically anisotropic layer had a maximum variation of 2.6% in the plane. As a result, the variation in effective in-plane phase difference of the optical film 4 was 4%.

In addition, the variation in orientation of the effective slow axis of the optical film 4 projected onto the plane perpendicular to the curved surface was 1.6°.

### [Production of Optical Film 5]

### <Forming Method 2>

The laminated optical body 1 was set in a forming device.

A forming space in the forming device consisted of a box 1 and a box 2, partitioned by the laminated optical body 1, and a convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold in the box 1 on the lower side of the laminated optical body 1, with the concave surface facing upward.

In addition, a transparent window was installed on the upper part of the box 2 on the upper side of the laminated optical body 1, and an IR light source for heating the laminated optical body 1 was installed on the outside of the forming device.

Next, each of the inside of box 1 and the inside of box 2 was evacuated to 0.1 atm or less by a vacuum pump.

Next, as a step of heating the laminated optical body 1, the laminated optical body 1 was irradiated with infrared rays and heated uniformly to 108° C. Since the glass transition temperature Tg of the PMMA film used as the support was 105° C., it was intended that the entire film was easily stretchable during the forming.

Next, as a step of pressing the laminated optical body 1 against the mold to the laminated optical body 1 along a shape of the mold, gas was allowed to flow into the box 2 from a gas cylinder to pressurize the optical film to 300 kPa, and the laminated optical body 1 was pressed against the mold. Finally, the laminated optical body 1 was removed from the mold which was a lens. In this way, an optical film 5 was obtained.

The optical film 5 had a curved surface having a curvature radius of 65 mm.

In a case where the measurement was carried out in the same manner as in the optical film 1, the surface area of the curved surface of the optical film 5 was 2111 mm². In addition, the projected area of the curved surface was 2027 mm². Therefore, a ratio R5 of the surface area of the curved surface to the projected area of the curved surface was 1.041. Accordingly, R5−1 was 0.041.

In a case where the thickness of the curved surface of the optical film 5 was measured in the same manner as in the optical film 1, the maximum thickness t_max5 was located at the end part of the curved surface and was 53 μm, and the minimum thickness t_min5 was located at the position of the optical axis and was 51.1 μm.

Therefore, (t_max5−t_min5)/t_min5=0.037, which did not satisfy (t_max−t_min)/t_min>R−1.

In the obtained optical film 5, a ratio t15/t25 of a thickness t15 of the first optically anisotropic layer to a thickness t25 of the second optically anisotropic layer had a maximum variation of 12% in the plane. As a result, the variation in effective in-plane phase difference of the optical film 5 was 15%.

In addition, the variation in orientation of the slow axis of the first optically anisotropic layer projected onto a plane perpendicular to the curved surface was a maximum of 2.9° in the plane. Furthermore, the variation in orientation of the slow axis of the second optically anisotropic layer projected onto a plane perpendicular to the curved surface was a maximum of 3.3° in the plane. As a result, the variation in orientation of the effective slow axis of the optical film 5 projected onto the plane perpendicular to the curved surface was 3.1°.

### [Production of Optical Film 6]

The forming was carried out in the same manner as in the optical film 1, except that the laminated optical body 1 was changed to the laminated optical body 5. In this way, an optical film 6 was obtained.

The optical film 6 had a curved surface having a curvature radius of 65 mm.

In a case where the measurement was carried out in the same manner as in the optical film 1, the surface area of the curved surface of the optical film 6 was 2111 mm². In addition, the projected area of the curved surface was 2027 mm². Therefore, a ratio R6 of the surface area of the curved surface to the projected area of the curved surface was 1.041. Accordingly, R6−1 was 0.041.

In a case where the thickness of the curved surface of the optical film 6 was measured in the same manner as in the optical film 1, the maximum thickness t_max6 was located at the end part of the curved surface and was 34 μm, and the minimum thickness t_min6 was located at the position of the optical axis and was 31.4 μm.

Therefore, (t_max6−t_min6)/t_min6=0.083, which satisfied (t_max−t_min)/t_min>R− 1.

### [Production of Optical Film 7]

The forming was carried out in the same manner as in the optical film 1, except that the laminated optical body 1 was changed to the laminated optical body 6. In this way, an optical film 7 was obtained.

The optical film 7 had a curved surface having a curvature radius of 65 mm.

In a case where the measurement was carried out in the same manner as in the optical film 1, the surface area of the curved surface of the optical film 7 was 2111 mm². In addition, the projected area of the curved surface was 2027 mm². Therefore, a ratio R7 of the surface area of the curved surface to the projected area of the curved surface was 1.041. Accordingly, R7−1 was 0.041.

In a case where the thickness of the curved surface of the optical film 7 was measured in the same manner as in the optical film 1, the maximum thickness t_max7 was located at the end part of the curved surface and was 28 μm, and the minimum thickness t_min7 was located at the position of the optical axis and was 25.9 μm.

Therefore, (t_max7−t_min7)/t_min7=0.081, which satisfied (t_max−t_min)/t_min>R−1.

### [Production of Optical Film 8]

The forming was carried out in the same manner as in the optical film 5, except that the laminated optical body 1 was changed to the laminated optical body 6. In this way, an optical film 8 was obtained.

The optical film 8 had a curved surface having a curvature radius of 65 mm.

In a case where the measurement was carried out in the same manner as in the optical film 1, the surface area of the curved surface of the optical film 8 was 2111 mm². In addition, the projected area of the curved surface was 2027 mm². Therefore, a ratio R8 of the surface area of the curved surface to the projected area of the curved surface was 1.041. Accordingly, R8−1 was 0.041.

In a case where the thickness of the curved surface of the optical film 8 was measured in the same manner as in the optical film 1, the maximum thickness t_max8 was located at the end part of the curved surface and was 28 μm, and the minimum thickness t_min8 was located at the position of the optical axis and was 27.3 μm.

Therefore, (t_max8−t_min8)/t_min8=0.026, which did not satisfy (t_max−t_min)/t_min>R−1.

### [Production of Lens 1]

In a case of forming the optical film 1, the laminated optical body 1 was bonded to a lens at the same time as the forming in which a pressure-sensitive adhesive sheet “NCF-D692 (15)” manufactured by LINTEC Corporation was bonded to a surface of the laminated optical body 1 in contact with the mold. In this way, a lens 1 was obtained.

### [Production of Lens 2]

In a case of forming the optical film 2, the laminated optical body 2 was bonded to a lens at the same time as the forming in which a pressure-sensitive adhesive sheet “NCF-D692 (15)” manufactured by LINTEC Corporation was bonded to a surface of the laminated optical body 2 in contact with the mold. In this way, a lens 2 was obtained.

### [Production of Lens 3]

In a case of forming the optical film 3, the laminated optical body 3 was bonded to a lens at the same time as the forming in which a pressure-sensitive adhesive sheet “NCF-D692 (15)” manufactured by LINTEC Corporation was bonded to a surface of the laminated optical body 3 in contact with the mold. In this way, a lens 3 was obtained.

### [Production of Lens 4]

In a case of forming the optical film 4, the laminated optical body 4 was bonded to a lens at the same time as the forming in which a pressure-sensitive adhesive sheet “NCF-D692 (15)” manufactured by LINTEC Corporation was bonded to a surface of the laminated optical body 4 in contact with the mold. In this way, a lens 4 was obtained.

### [Production of Lens 5]

In a case of forming the optical film 5, the laminated optical body 1 was bonded to a lens at the same time as the forming in which a pressure-sensitive adhesive sheet “NCF-D692 (15)” manufactured by LINTEC Corporation was bonded to a surface of the laminated optical body 1 in contact with the mold. In this way, a lens 5 was obtained.

### [Production of Lens 6]

In a case of forming the optical film 6, the laminated optical body 5 was bonded to a lens at the same time as the forming in which a pressure-sensitive adhesive sheet “NCF-D692 (15)” manufactured by LINTEC Corporation was bonded to a surface of the laminated optical body 5 in contact with the mold. In this way, a lens 6 was obtained.

### [Production of Lens 7]

In a case of forming the optical film 7, the laminated optical body 6 was bonded to a lens at the same time as the forming in which a pressure-sensitive adhesive sheet “NCF-D692 (15)” manufactured by LINTEC Corporation was bonded to a surface of the laminated optical body 6 in contact with the mold. In this way, a lens 7 was obtained.

### [Production of Lens 8]

In a case of forming the optical film 8, the laminated optical body 6 was bonded to a lens at the same time as the forming in which a pressure-sensitive adhesive sheet “NCF-D692 (15)” manufactured by LINTEC Corporation was bonded to a surface of the laminated optical body 6 in contact with the mold. In this way, a lens 8 was obtained.

### [Evaluation of Produced Retardation Film]

In all of the obtained optical films 1 to 6, the effective phase difference before the forming was Re=141 nm. The in-plane variation in the effective phase difference of the optical film after the forming and the in-plane variation in the orientation of the effective slow axis projected onto the plane perpendicular to the optical axis of the curved surface are shown in Table 4.

### Production of Virtual Reality Display Apparatus of Example 1

A virtual reality display apparatus “Huawei VR Glass” (manufactured by Huawei Technologies Co., Ltd.), which was a virtual reality display apparatus for which a pancake lens was employed, was disassembled, and all composite lenses were taken out. Instead of the composite lens, the above-described lens 1 was incorporated into the main body to produce a virtual reality display apparatus of Example 1.

### Production of Virtual Reality Display Apparatuses of Examples 2 to 6

Virtual reality display apparatuses of Examples 2 to 6 were produced in the same manner as in Example 1, except that the lens 1 was changed to the lenses 2 to 4, the lens 6, and the lens 7 described above.

### Production of Virtual Reality Display Apparatus of Comparative Example 1

A virtual reality display apparatus of Comparative Example 1 was produced in the same manner as in Example 1, except that the lens 1 was changed to the above-described lens 5.

### Production of Virtual Reality Display Apparatus of Comparative Example 2

A virtual reality display apparatus of Comparative Example 2 was produced in the same manner as in Example 1, except that the lens 1 was changed to the above-described lens 8.

### <Evaluation of Ghost>

In the produced virtual reality display apparatus, a black-and-white checkered pattern was displayed on an image display panel, and ghost visibility was visually evaluated in terms of the following four stages.
A: ghost was slightly visible, but not noticeable.
B: weak ghost was visible.
C: slightly strong ghost was visible.
D: strong ghost was visible.

Table 4 shows the forming method and the type of optical film used in each of Examples and Comparative Examples. In addition, the evaluation results thereof are described in Table 5.

As shown in Table 5, in the virtual reality display apparatuses of Examples 1 to 6, the ghost was good over the entire region of visual field.

TABLE 4
Forming method and type of optical film used in Examples and Comparative Examples

| | | | | Variation in | variation in |
|---|---|---|---|---|---|
| | Composite | Forming | Film before | effective phase | orientation of |
| | lens | method | forming | difference | effective slow axis |
| Example 1 | Lens 1 | Forming | Laminated | 4% | 1.3° |
| | | method 1 | optical body 1 | | |
| Example 2 | Lens 2 | Forming | Laminated | 8% | 1.5° |
| | | method 1 | optical body 2 | | |
| Example 3 | Lens 3 | Forming | Laminated | 3% | 1.2° |
| | | method 1 | optical body 3 | | |
| Example 4 | Lens 4 | Forming | Laminated | 4% | 1.6° |
| | | method 1 | optical body 4 | | |
| Example 5 | Lens 5 | Forming | Laminated | 3% | 1.2° |
| | | method 1 | optical body 5 | | |
| Comparative | Lens 6 | Forming | Laminated | 15% | 3.1° |
| Example 1 | | method 2 | optical body 1 | | |

TABLE 5
Evaluation results of Examples and Comparative Examples

Ghost visibility

| | Central portion of | End portion of |
|---|---|---|
| | visual field | visual field |
| Example 1 | A | A |
| Example 2 | B | A |
| Example 3 | A | A |
| Example 4 | A | A |
| Example 5 | A | A |
| Example 6 | A | A |
| Comparative | D | D |
| Example 1 | | |
| Comparative | D | D |
| Example 2 | | |

The present invention can be suitably used in various optical apparatuses such as a virtual reality display apparatus.

### EXPLANATION OF REFERENCES

10, 12: optical film
20, 50: virtual reality display apparatus
24: image display panel
26, 30, 36: λ/4 wavelength plate
28, 40: absorption type linear polarizer
32: half mirror
34: lens base material
36: λ/4 wavelength plate
38: reflective linear polarizer
52: reflective circular polarizer
240, 250: forming die
242, 252: optical film
242C, 252C: central portion of optical film
242R, 252R: periphery portion of optical film

What is claimed is:

1. An optical film having a curved surface,
wherein an average curvature radius on the curved surface is 30 to 1,000 mm, and
in a case where a maximum thickness of the optical film on the curved surface is denoted as t_max and a minimum thickness of the optical film on the curved surface is denoted as t_min,
(t_max−t_min)/t_min>R−1 is satisfied,
here, R is a ratio of a surface area of the curved surface to a projected area of the curved surface projected onto a plane perpendicular to an optical axis.

2. The optical film according to claim 1,
wherein the optical film comprises at least a retardation layer,
the retardation layer includes at least a first optically anisotropic layer and a second optically anisotropic layer, and
in a case where a thickness of the first optically anisotropic layer at a point X on the curved surface is denoted as t1(x) and a thickness of the second optically anisotropic layer at the point X is denoted as t2(x), a variation of t1(x)/t2(x) on the curved surface is less than 5%.

3. The optical film according to claim 2,
wherein a variation in slow axis of each of the first optically anisotropic layer and the second optically anisotropic layer is less than 2°.

4. The optical film according to claim 3,
wherein an in-plane phase difference of the first optically anisotropic layer at a wavelength of 550 nm is in a range of 120 to 160 nm, and an in-plane phase difference value of the second optically anisotropic layer is 200 to 320 nm.

5. The optical film according to claim 4,
wherein the first optically anisotropic layer and the second optically anisotropic layer are layers formed by immobilizing at least a liquid crystal compound.

6. The optical film according to claim 2,
wherein the first optically anisotropic layer is a layer formed by immobilizing at least a liquid crystal compound and is a positive A-plate, and the second optically anisotropic layer is a layer formed by immobilizing a twist-aligned liquid crystal compound, the layer having a helical axis along a thickness direction.

7. The optical film according to claim 6,
wherein an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

8. The optical film according to claim 2,
wherein the first optically anisotropic layer is a layer formed by immobilizing a twist-aligned liquid crystal compound, the layer having a helical axis along a thickness direction, the second optically anisotropic layer is a layer formed by immobilizing a twist-aligned liquid crystal compound, the layer having a helical axis along a thickness direction, and a helical pitch of the first optically anisotropic layer is different from a helical pitch of the second optically anisotropic layer.

9. The optical film according to claim 8,
wherein an alignment direction of the liquid crystal compound contained in the first optically anisotropic layer and an alignment direction of the liquid crystal compound contained in the second optically anisotropic layer are continuous at an interface between the first optically anisotropic layer and the second optically anisotropic layer.

10. The optical film according to claim 2,
wherein any of the first optically anisotropic layer or the second optically anisotropic layer has reverse wavelength dispersibility.

11. The optical film according to claim 10,
wherein both the first optically anisotropic layer and the second optically anisotropic layer have reverse wavelength dispersibility.

12. The optical film according to claim 1,
wherein the optical film comprises at least an absorptive polarizer, and in a case where an orientation of an absorption axis of the absorptive polarizer in the curved surface is projected onto a plane, a variation of the projected orientation of the absorption axis is less than 2°.

13. The optical film according to claim 1,
wherein the optical film comprises at least a reflective linear polarizer, and in a case where an orientation of a reflection axis of the reflective linear polarizer in the curved surface is projected onto a plane, a variation of the projected orientation of the reflection axis is less than 2°.

14. The optical film according to claim 1,
wherein the optical film comprises at least a reflective circular polarizer.

15. The optical film according to claim 14,
wherein the reflective circular polarizer includes a cholesteric liquid crystal layer.

16. The optical film according to claim 1,
wherein a film thickness of the optical film generally thins from an end part of the curved surface toward a bottom portion of the curved surface.

17. The optical film according to claim 1,
wherein a film thickness of the optical film generally thicks from an end part of the curved surface toward a bottom portion of the curved surface.

18. A lens comprising:
the optical film according to claim 1.

19. A virtual reality display apparatus comprising:
the lens according to claim 18.

20. The optical film according to claim 2,
wherein an in-plane phase difference of the first optically anisotropic layer at a wavelength of 550 nm is in a range of 120 to 160 nm, and an in-plane phase difference value of the second optically anisotropic layer is 200 to 320 nm.
